(19) United States
(12) Patent Application Publication
(10) Pub. No.: US 2005/0061356 A1
(43) Pub. Date: Mar. 24, 2005

(54) Cleaning sheets

(75) Inventors: Arthur Wong, West Chester, OH (US); Leah M. Wood, Park Hills, KY (US); Jeffery Lawrence Flora, Mason, OH (US); Douglas Michael McGahan, Milford, OH (US); Andrew W. Delaney, East Windsor, NJ (US); Rick M. Augustine, Sherrills Ford, NC (US)

Correspondence Address: THE PROCTER & GAMBLE COMPANY;INTELLECTUAL PROPERTY DIVISION, WINTON HILL TECHNICAL CENTER - BOX 161, 6110 CENTER HILL AVENUE, CINCINNATI, OH, 45224, US

(73) Assignee: The Procter & Gamble Company

(21) Appl. No.: 10/782,033

(22) Filed: Feb. 19, 2004

Related U.S. Application Data
(60) Provisional application No. 60/448,396, filed on Feb. 19, 2003.

(51) Int. Cl. B32B 1/00

(52) U.S. Cl. 134/6; 428/178; 15/228; 15/208

(57) ABSTRACT

The present invention provides a cleaning sheet which has a plurality of pillow members on at least one of the outer surfaces of the sheet. The plurality of pillow members creates a three-dimensional pattern on the outer surface of the sheet. The cleaning sheet has a flow path or channels for particulates in between the pillow members which allows the particulates to migrate towards the middle portion of the sheet during the cleaning of a hard surface with the sheet.

### CROSS-REFERENCE TO RELATED APPLICATIONS

This application claims the benefit of U.S. Provisional Application No. 60/448,396, filed Feb. 19, 2003.

### FIELD OF THE INVENTION

This invention relates to cleaning sheets particularly suitable for removal and entrapment of dust, lint, hair, sand, food crumbs, grass and the like.

### BACKGROUND OF THE INVENTION

The use of nonwoven sheets for dry dust-type cleaning are known in the art. Such sheets typically utilize a composite of fibers where the fibers can be thermally or adhesively bonded or bonded via entangling or other forces. See, for example, U.S. Pat. No. 3,629,047 and U.S. Pat. No. 5,144,729. The cleaning sheets can be used either for hand dusting or in combination with a cleaning implement such as the SWIFFER® cleaning implement sold by The Procter & Gamble Company or the PLEDGE GRAB-IT® cleaning implement sold by the S.C. Johnson Company. When the cleaning sheet is used with a cleaning implement, the sheet is typically mechanically attached to the mop head of the cleaning implement, via grippers located on the top surface of the mop head, such that a portion of the cleaning sheet is in contact with the floor being cleaned in order to collect and trap soils such as dust, lint, crumbs and other particles. The cleaning performance of a cleaning sheet can be defined by its “cleaning efficacy”, which relates to the capability/ability of the sheet to pickup soil in terms of amount or weight of particulates being trapped in the sheet, but also in terms of “cleaning efficiency” which relates to the surface of the sheet being actually used in comparison to the total surface of the sheet, in particular when the sheet is being used with a cleaning implement. Some cleaning implements include a mop head which has a substantially flat bottom surface such as the one described in U.S. Pat. No. 6,305,046 to Kingry et al, issued Nov. 23, 2001, and assigned to The Procter and Gamble Company. When a cleaning sheet is used with such a cleaning implement and then is removed from the mop head, it can be observed that dust and particles tend to accumulate in the portions of the sheet which were adjacent to the front and back leading edges of the mop head, leaving the middle portion of the sheet substantially unused. Several attempts have been made to increase the “cleaning efficiency” of the mopping operation by changing the flat bottom surface of the implement to expose more of the cleaning sheet. For example, in order to increase the leading edge surface area between a cleaning sheet and the floor surface, a mop head is provided with a “crowned” or curved bottom surface allowing the mop head “to rock or tilt forward and backward” during the mopping operation and, as a result, to enable a greater portion of the sheet to be in contact with soil on the floor surface. An example of such a cleaning implement having a mop head with a crowned bottom surface is described in U.S. patent application Ser. No. 09/788,761 to Willman et al., filed Feb. 24, 2000, and assigned to The Procter & Gamble Company. In addition, the bottom surface of the cleaning implement can also have a three-dimensional texture in order to increase the open area between the contact surface of the cleaning sheet against the floor surface also described in U.S. patent application Ser. No. 09/788,761 to Willman et al. Another solution to improve the mopping operation and increase the “cleaning efficacy” of a cleaning sheet is to include an additive to the cleaning sheet such as the ones described in U.S. patent application Ser. No. 09/082,349 to Fereshtehkhou et al., filed May 20, 1998, and assigned to The Procter & Gamble Company, in order to enhance the pick-up and retention of soils. Another solution to increase the “cleaning efficacy” of the cleaning sheet is to create of three-dimensional texture on both surfaces of the cleaning sheet. U.S. patent application Ser. No. 09/082,396 to Fereshtehkhou et al., filed May 20, 1998, and assigned to The Procter & Gamble Company discloses such cleaning sheets having a three-dimensional texture.

Despite all these efforts to improve the “cleaning efficiency” of the cleaning sheet, it can still be observed that a portion of the sheet remains unused as the particles tend to accumulate or “aggregate” along the front and back leading edges of the sheet and, as a result, still leave a portion of the cleaning sheet unused.

As such, there is a continuing need to provide cleaning sheets that offer both improved soil removal and improved or more complete sheet utilization. In this regard, it is found that by providing at least one of the sides of a cleaning sheet with pillow members and a flow path for particulates in between the pillow members, the cleaning efficiency and efficacy of the sheet are improved as the particles are able to reach a larger surface of the cleaning sheet and as the sheet is removing more and larger particulates from the surface being cleaned.

Accordingly, it is an object of this invention to overcome the problems of the prior art and particularly to provide a cleaning sheet having a greater “cleaning efficacy and cleaning efficiency”. Specifically, it is an object of this invention to provide a nonwoven structure having significant three-dimensionality, which is described in detail hereinafter.

When a cleaning sheet is used with a cleaning implement as previously described, it is “sandwiched” between the mop head and the hard surface being cleaned. It has been observed that when cleaning sheets, such as the ones currently available on the market, are used to clean a hard surface having rugosities, holes or grout lines, these cleaning sheets are not capable of removing the dust or particles which are lodged therein. During the cleaning operation, known cleaning sheets tend to flatten (due to pressure applied by the user) and substantially remain flat even when the sheets are moved across grout lines, a holes or other asperities or rugosities. Since these cleaning sheets cannot expand within these grout lines nor conform to the grout lines' shape, they cannot remove particulates lodged therein.

It is therefore another object of the invention to provide a cleaning sheet having a substantially non-random three-dimensional texture or pattern which has good rebound properties, good conformability of protrusions to surface rugosities and is able to recover its original shape after it has been removed from a package and/or when it is moved across a hole or grout line of the hard surface being cleaned.

The fibrous material(s) (preferably a nonwoven material) which is used to make the cleaning sheet, includes pores or voids which trap particulates when a hard surface is wiped with the cleaning sheet. The number and size of these pores/voids have an impact on the “cleaning efficacy” of the sheet, i.e., on the amount and size of the particulates the cleaning sheet can remove. The number and size of the pores/voids are related to the void volume of the substrate material which can be determined when the basis weight (expressed in g/m²) and thickness (or caliper) of the substrate material used to make the cleaning sheet are known. During a typical cleaning operation, the substrate material forming the cleaning sheet is compressed due to the pressure which is applied by the user. Consequently, the void volume of the sheet decreases locally and the size of the pores/voids decreases. As the size of the pores/voids decreases, the “cleaning efficacy” of the sheet decreases as well.

It is therefore another object of the invention to provide a cleaning sheet, preferably having pillow members extending from at least one of its outer surfaces, which maintains a large void volume when pressure is applied to the cleaning sheet.

### SUMMARY OF THE INVENTION

The invention disclosed herein relates to cleaning sheet for removing particulates from a hard surface comprising a substrate, said substrate having a length and a width, said substrate comprising a first side and a second side wherein said first side comprises a plurality of pillow members and wherein said pillow members create a macroscopic three-dimensional pattern on said first side.

The invention also relates to a cleaning sheet for removing particulates from a hard surface comprising a substrate having a length, a width and a thickness, said substrate comprising at least one layer of fibrous nonwoven material, wherein said substrate has a void volume of at least about 21 cm³/(gram of substrate) when said substrate is subjected to a compressive force of less than about 0.5 g/cm², preferably between about 0.1 g/cm² and about 0.5 g/cm².

The invention relates to a cleaning sheet for removing particulates from a hard surface comprising a substrate having a length, a width and a thickness, said substrate comprising at least one layer of fibrous nonwoven material, wherein said substrate has a void volume of at least about 17.5 cm³/(gram of substrate) when said substrate is subjected to a compressive force of between about 0.5 g/cm² and about 1 g/cm².

The invention also relates to a method of removing particulates from a hard surface comprising providing a cleaning sheet according to claim 38 and contacting said hard surface with said first side of said cleaning sheet.

The invention relates to a cleaning kit comprising at least one cleaning sheet and a cleaning implement comprising a handle.

All documents cited herein are, in relevant part, incorporated herein by reference; the citation of any document is not to be construed as an admission that it is prior art with respect to the present invention.

It should be understood that every maximum numerical limitation given throughout this specification will include every lower numerical limitation, as if such lower numerical limitations were expressly written herein. Every minimum numerical limitation given throughout this specification will include every higher numerical limitation, as if such higher numerical limitations were expressly written herein. Every numerical range given throughout this specification will include every narrower numerical range that falls within such broader numerical range, as if such narrower numerical ranges were all expressly written herein.

All parts, ratios, and percentages herein, in the Specification, Examples, and claims, are by weight and all numerical limits are used with the normal degree of accuracy afforded by the art, unless otherwise specified.

### BRIEF DESCRIPTION OF THE DRAWINGS

FIG. 1 is a top view of a cleaning sheet comprising a plurality of pillow members;

FIG. 2 is a close-up view of the pillow members shown in FIG. 1;

FIG. 3 is a cross-sectional view of the pillow members of FIG. 2;

FIG. 4 is a top view of another cleaning sheet comprising a plurality of pillow members;

FIG. 5 is a close-up view of the pillow members shown in FIG. 4;

FIG. 6 is a top view of a cleaning sheet comprising a plurality of longitudinal pillow members;

FIG. 7 is a close-up view of the longitudinal pillow members shown in FIG. 6;

FIG. 8 is a side elevation view of the pillow members of FIG. 7;

FIG. 9 is a close-up view of another arrangement of longitudinal pillow members;

FIG. 10 is a close-up view of another arrangement of longitudinal pillow members;

FIG. 11 is a close-up view of a longitudinal pillow member in a “zig-zag” pattern;

FIG. 12 is a side elevation view of the longitudinal member of FIG. 11;

FIG. 13 is a top view of a cleaning sheet comprising a plurality of V-shaped pillow members;

FIG. 14 is a close-up view of the V-shaped pillow members shown in FIG. 13;

FIG. 15 is a side elevation view of the V-shape pillow members of FIG. 14;

FIG. 16 is a top view of a cleaning sheet comprising another arrangement of a plurality of V-shaped pillow members;

FIG. 17 is a close-up view of the V-shaped pillow members shown in FIG. 16;

FIG. 18 is another close-up view of the V-shaped pillow members shown in FIG. 16;

FIG. 19 is a top view of a cleaning sheet comprising another arrangement of a plurality of V-shaped pillow members;

FIG. 20 is a close-up view of the V-shaped pillow members shown in FIG. 19;

FIG. 21 is a top view of a cleaning sheet comprising a plurality of octopus-shaped pillow members;

FIG. 22 is a close-up view of the octopus-shaped pillow members shown in FIG. 21;

FIG. 23 is a top view of a cleaning sheet comprising another arrangement of a plurality of V-shaped pillow members;

FIG. 24 is a top view of a cleaning sheet comprising another arrangement of a plurality of V-shaped pillow members;

FIG. 25 is a top view of a cleaning sheet comprising a plurality of pillow members;

FIG. 26 is a top view of a cleaning sheet comprising a plurality of pillow members;

FIG. 27 is a schematic representation of a suitable manufacturing process of a cleaning sheet comprising a plurality of pillow members;

FIG. 28 is a top view of the imaging device of FIG. 27;

FIG. 29 is a cross-sectional view of the imaging device of FIG. 28;

FIG. 30 is a top view of an imaging device suitable to create V-shaped pillow members;

FIG. 31 is a picture of the side of a cleaning sheet comprising a plurality of pillow members before a pillow member reaches a groove;

FIG. 32 is a picture of the side of a cleaning sheet of FIG. 31 when the pillow member reaches the groove;

FIG. 33 is a picture of the side of a cleaning sheet of FIG. 32 when the pillow member expands within the groove;

FIG. 34 is a picture of the bottom surface of a sheet having a plurality of pillow members during the cleaning operation;

FIG. 35 is a picture of the bottom surface of a sheet of FIG. 34 at a later time of the cleaning operation;

FIG. 36 is a picture of the bottom surface of a sheet of FIG. 35 at a later time of the cleaning operation;

FIG. 37 shows a graph of the caliper of web samples as a function of compression force applied to the webs;

FIG. 38 shows a graph of the web void volume of web samples as a function of the compression force applied to the webs; and

FIG. 39 is a cleaning implement for cleaning a hard surface.

### DETAILED DESCRIPTION OF THE INVENTION

While not intending to limit the utility of the cleaning sheet herein, it is believed that a brief description of its use in association with a modern mopping implement will help elucidate the invention.

In heretofore conventional dry-mopping operations, the user wipes a hard surface with a cleaning sheet by holding the sheet in his/her hand or by attaching the sheet to a handle. In order to clean large surfaces such as floor surfaces, the common practice is to mechanically attach the cleaning sheet to the mop head of a cleaning implement, which is described in greater details in section VI infra, and then mop the surface in order to trap particles into and/or onto the cleaning sheet. Conventional mop heads have a substantially rectangular shape with a length of between about 255 and about 430 mm and a width of between about 90 mm and 127 mm. Conventional cleaning sheets typically also have a substantially rectangular shape and are sized such that they are removably attachable to the mop head. The size of conventional cleaning sheets varies between about 470 and about 275 mm in length and between about 200 and about 270 mm in width. One skilled in the art will understand that a cleaning sheet can have a different size and/or shape still provide the same benefits.

Conventional cleaning sheets are made of one or more nonwoven layer of fibrous material which is typically made via an hydroentanglement process in order to provide a fibrous material or fabric capable of trapping particles of various sizes. The outer surfaces, i.e., top and bottom surfaces, of conventional cleaning sheets are substantially flat (at least on a macroscopic level) and consequently are not capable of dislodging particles located in the asperities or grout lines of a floor surface. Conventional cleaning sheets used for dry dusting a surface are substantially free of water. Additives, such as waxes, oils, or mixtures of waxes and oils, can be applied to these cleaning sheets in order to increase the cleaning efficacy of the sheets by enhancing the particles pick-up and retention of the cleaning sheet but nevertheless, these additives do not allow these sheets to reach “deep” into the asperities of the surface being cleaned.

Modern cleaning sheets can have a three-dimensional texture or pattern on at least one of their outer surfaces in order to increase the cleaning sheet's open surface area available between the cleaning sheet and the hard surface. One suitable method to create texture on a cleaning sheet is disclosed in U.S. patent application Ser. No. 09/082,396 to Fereshtehkhou et al. where a fibrous layer of polyester can be hydroentangled with a scrim made of polypropylene and is then heated. The heat applied to the sheet causes the scrim to shrink thereby creating a three-dimensional macroscopic texture, which is random in nature, on at least one of the outer surfaces of the sheet. However, it has been observed that if these cleaning sheets were compressed to be packaged, or simply when the cleaning sheets are being used with a cleaning implement, these sheets tend to flatten and do not adequately produce or generate sufficient macroscopic three-dimensional texture for cleaning the asperities. These sheets also do not have sufficient overall thickness/bulk to clean soils lodged in crevices, grout lines, etc. Consequently, these sheets lose part of the benefits provided by their three-dimensional textured outer surfaces. In addition, it is believed that the random pattern/texture obtained on the cleaning sheet does not allow the sheet to contact with the dust/particles optimally.

Early cleaning implements include a handle rotationally connected to a mop head having a substantially flat bottom surface. When such a cleaning implement is used with either conventional or modern cleaning sheets, a sizeable quantity of the dust and/or particles tend to accumulate on the portion of the cleaning sheet adjacent to the front and back leading edges of the mop head. As a result, a large portion of the sheet is left unused.

In an effort to solve this problem, modern mopping implements include a mop head having a “crowned” bottom surface, i.e., a curved bottom surface having a constant or variable angle of curvature, which can also be textured. The “rocking” or tilting forward and backward action of the mop head during the cleaning operation, in combination with the textured bottom surface of the mop head increases the cleaning efficiency of either conventional or modern cleaning sheets. Unfortunately, it has been observed that a relatively large portion of the sheet remains unused as dust and/or particles continues to accumulate without being able to reach a sizeable portion of the sheet. When a cleaning sheet is used with a cleaning implement having a curved mop head, it has been observed that the front and back portions of the sheet remain unused.

Although the previously discussed improvements, increased to a certain degree the cleaning efficiency of the cleaning sheets used either alone or in combination with a cleaning implement, it is believed that both the overall cleaning efficiency and efficacy can be further increased by creating an improved three-dimensional texture or pattern on at least one of the outer surfaces of cleaning sheet. This three-dimensional texture or pattern can have channels or flow paths, located in between a plurality of pillow members, which allow the dust/particles to reach a larger area of the sheet. The three-dimensional texture or pattern is preferably non-random in nature. In a nutshell, these paths or channels allow the particles “to flow” towards the centered portion of the sheet and as a result, improve the usefulness (i.e., efficiency) of the sheet. In addition, when at least one side of a cleaning sheet, which has a plurality of pillow members, is used to clean a hard surface with a cleaning implement which has a curved mop head, such that the side having these pillow members is in contact with the hard surface, the front and back portion of the sheet contribute to clean the hard surface. The pillow members located in the front and back portions of the sheet expand from the sheet towards the hard surface and are capable of contacting the hard surface being cleaned.

It is also believed that the cleaning efficacy of the sheet can be improved by providing a cleaning sheet with a macroscopic three-dimensional pattern or texture which is capable of recovering its original three-dimensional shape when pressure ceases to be applied to the sheet such that the pillow members can conform to the changes in topography of the surface being cleaned (e.g., grout lines or transition strips). The three dimensional pattern also directs soils and larger particulates to specific areas/zones of the cleaning sheet so that the soil/particulates will be trapped or contained.

The foregoing considerations are addressed by the present invention, as will be clear from the detailed disclosures which follow.

Reference will now be made in detail to the present preferred embodiments of the invention, examples of which are illustrated in the accompanying drawings wherein like numerals indicate the same elements throughout the views and wherein reference numerals having the same last two digits (e.g., 20 and 120) connote similar elements.

I. Definitions

As used herein, the term “comprising” means that the various components, ingredients, or steps, can be conjointly employed in practicing the present invention. Accordingly, the term “comprising” encompasses the more restrictive terms “consisting essentially of” and “consisting of”.

As used herein, the term “hydroentanglement” means generally a process for making a material wherein a layer of loose fibrous material (e.g., polyester) is supported on an apertured patterning member and is subjected to water pressure differentials sufficiently great to cause the individual fibers to entangle mechanically to provide a fabric. The apertured patterning member can be formed, e.g., from a woven screen, a perforated metal plate, etc.

As used herein, the term “pillow member” means a macroscopic three-dimensional structure formed by at least two layers of fibrous material defining the outer surfaces of the structure and having a volume in between these two layers. A suitable analogy to the “pillow members” are the macroscopic three-dimensional structures found in “bubble wrap.” The inner volume of a “pillow member” can be substantially hollow (i.e., only defined by its outer fibrous layers) or partially filled with fibers (i.e., some fibers occupy some of the volume in between its outer layers).

As used herein, the term “Z-dimension” refers to the dimension orthogonal to the length and width of the cleaning sheet of the present invention, or a component thereof. The Z-dimension usually corresponds to the direction of the thickness of the sheet.

As used herein, the term “X-Y dimension” refers to the plane orthogonal to the thickness of the cleaning sheet, or a component thereof. The X and Y dimensions usually correspond to the length and width, respectively, of the sheet or a sheet component.

As used herein, the term “layer” refers to a member or component of a cleaning sheet whose primary dimension is X-Y, i.e., along its length and width. It should be understood that the term layer is not necessarily limited to single layers or sheets of material. Thus the layer can comprise laminates or combinations of several sheets or webs of the requisite type of materials. Accordingly, the term “layer” includes the terms “layers” and “layered.”

For purposes of the invention described herein, an “upper” layer of a cleaning sheet is a layer that is relatively further away from the surface that is to be cleaned (i.e., in the implement context, relatively closer to the implement handle during use). The term “lower” layer conversely means a layer of a cleaning sheet that is relatively closer to the surface that is to be cleaned (i.e., in the implement context, relatively further away from the implement handle during use). Reciprocally, the “top surface” of a layer or cleaning sheet is the surface that is relatively further away from the surface to be cleaned. The term “bottom surface” conversely means the surface of the layer or cleaning sheet that is relatively closer to the surface that is to be cleaned, during a typical cleaning operation.

As used herein, the term “macroscopic three-dimensionality”, when used to describe three-dimensional cleaning sheets, means the three-dimensional pattern is readily visible to the naked eye when the perpendicular distance between the viewer's eye and the plane of the sheet is about 30 cm. In other words, the three-dimensional structures of the present invention are cleaning sheets that are non-planar, in that one of the surfaces of the sheet exist in multiple planes, where the distance between those planes is observable to the naked eye when the structure is observed from about 30 cm. By way of contrast, the term “planar” refers to cleaning sheets having fine-scale surface aberrations on one or both sides, the surface aberrations not being readily visible to the naked eye when the perpendicular distance between the viewer's eye and the plane of the web is about 30 cm or greater. In other words, on a macroscale, the observer would not observe that one or both surfaces of the sheet exist in multiple planes so as to be three-dimensional. The macroscopically three-dimensional structures of the present invention optionally comprise a scrim material.

II. Cleaning Sheets

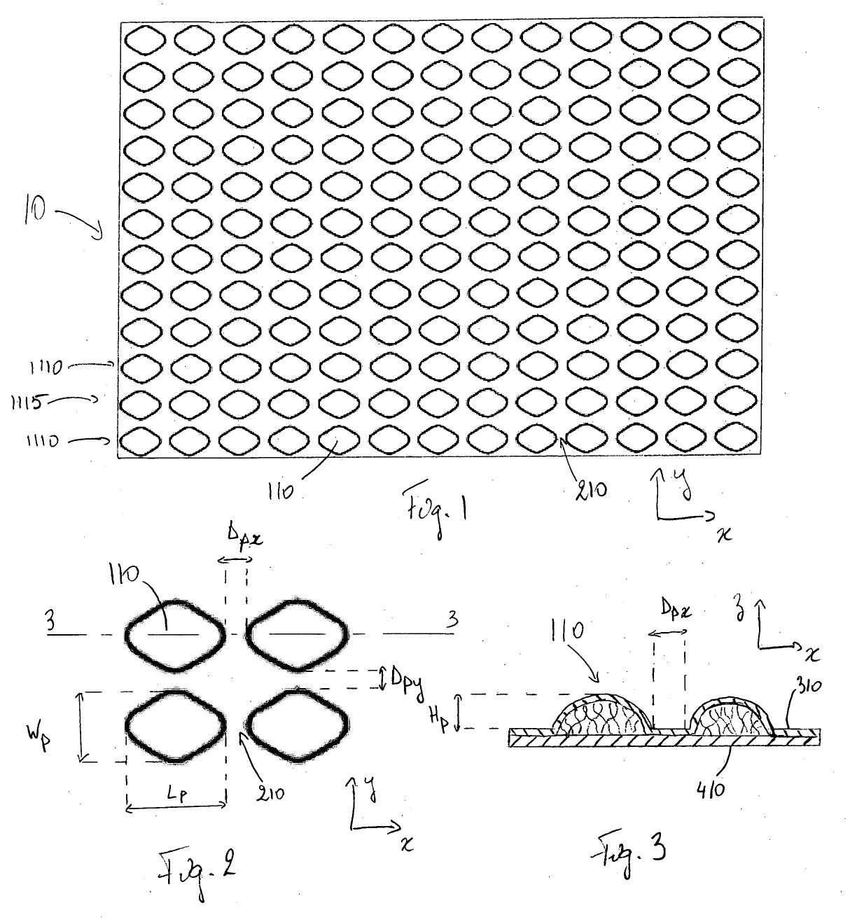

Referring to FIG. 1, one outer surface of a cleaning sheet 10, which can be mechanically and removably attached to the mop head of a cleaning implement (not shown) is represented. This outer surface comprises a three-dimensional texture or pattern defined by a plurality of pillow members 110, extending outwardly from the outer surface of cleaning sheet. The cleaning sheet 10 can be made of one or more layers of fibrous material which are then subjected to an image forming process which will be described in section III in greater details. In a preferred embodiment, the cleaning sheet 10 comprises three layers of fibrous material. A first and a second layer of carded web material are slightly hydroentangled respectively to the top and the bottom surface of a “support” layer. In one embodiment, the support layer can be a spunbond layer made of polypropylene. The resulting nonwoven substrate is then subjected to the imaging process to create the pillow members 110.

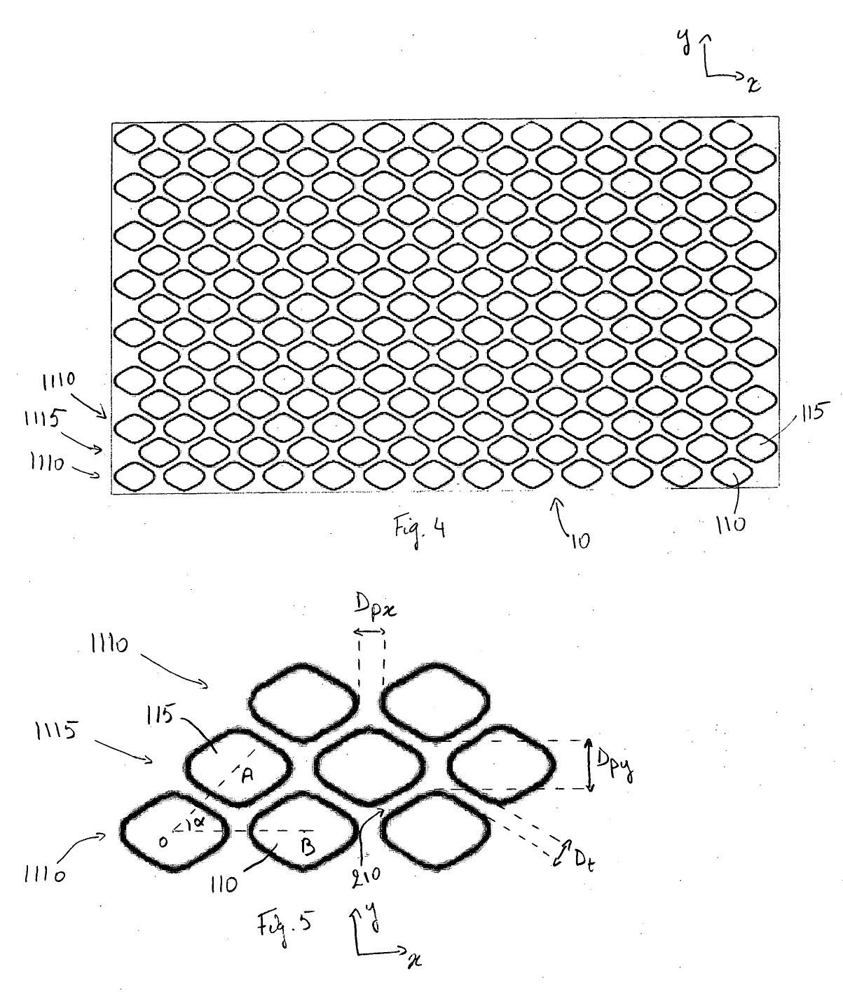

FIG. 2 is a close-up top view where a plurality of pillow members are represented. A pillow member 110 can be defined by its length Lp, its width Wp, and its height Hp (shown in FIGS. 2 and 3). The space in between pillow members can be defined by the distance Dpx and Dpy (shown in FIGS. 2 and 3).

FIG. 3 is a cross-section view of the portion of the sheet shown in FIG. 2 along the 3-3 axis. The base substrate used to make the sheet 10 comprises at least a first layer 310 and a second layer 410 of a nonwoven material. In one embodiment, portions of the first layer 310 extend away (i.e., in the Z direction) from the second layer 410 in order to form the pillow members 110. For clarity purposes, it will be understood that the length Lp and width Wp are measured in the X-Y plane and represent respectively the greatest length of a pillow member on the X axis and the greatest width of a pillow member on the Y axis. The height Hp is measured in the Z dimension and represents the longest height of a pillow member on the Z axis. One skilled in the art will understand that the dimension Hp represents the height of the pillow members and does not include the thickness of the base substrate which carries the pillow members. In addition, one skilled in the art will understand that the dimension Hp also represents the “depth” of the “valley” or flow path in between two pillow members. The distance Dpx is the closest distance between two consecutive pillow members of a same row (i.e., along the X axis) and the distance Dpy is the closest distance between two pillow members of two consecutive rows. In one embodiment, Lp is between about 2 and 125 mm, preferably between about 3 and 75 mm, more preferably between about 4 and 50 mm, Wp is between about 2 and 125 mm, preferably between about 3 and 75 mm, more preferably between about 4 and 50 mm and Hp is between about 0.50 and 12.0 mm, preferably between about 0.75 and 10.0 mm, and more preferably between about 0.90 and 9.0 mm. One skilled in the art will understand that by varying the dimensions Lp, Wp and Hp, it is possible to adjust the overall shape of the pillow members 110. Non-limiting examples of cross-sectional shapes in the X-Y plane which are suitable for the pillow members 110 include, square, rectangle, parallelogram, trapezium, triangle, polygon, circle, annulus, sector of a circle, segment of a circle, ellipse, segment of ellipse or any other geometrical shape or combinations of geometrical shapes. In a three-dimensional sense, these base planar shapes when extruded (in the Z-direction) can provide a cube, cuboid, parallelepiped, pyramid, frustum of pyramid, cylinder, hollow cylinder, hollow cylinder, cone, frustum of cone, segment of a sphere, zone of a sphere, sector of a sphere, sliced cylinder, ungula, prismoid, any other three dimensional shape or combinations of three dimensional shapes to the pillow members 110. Example drawings of these two dimensional and three dimensional shapes can be found in Engineering Formulas, 5^{th} edition, Kurt Gieck, McGraw-Hill Book Company, New York N.Y. In one embodiment, a plurality of pillow members 110 can be created on at least one of the outer surfaces of the cleaning sheet 10 in order to obtain rows or lines 1110 of pillow members as shown in FIG. 1. In one embodiment, the distance Dpx between two consecutive pillow members of a same row is between about 0.1 and about 20 mm, preferably between about 0.5 and about 10 mm, more preferably between about 1.0 and 8 mm and the distance Dpy between two adjacent pillow members of two consecutive rows is between about 0.1 and about 20 mm, preferably between about 0.5 and about 10 mm, more preferably between about 1.0 and 8 mm.

In a preferred embodiment, the row(s) 1110 of pillow members 110 are substantially parallel to the length (corresponding to the front and back leading edges) of the sheet 10. In one embodiment, a cleaning sheet 10 can have a plurality of rows 1110 of pillow members 110 which are preferably parallel to each other. In one embodiment, two consecutive rows 1110 and 1115 can be located on the sheet such that the pillow members 110 are aligned both vertically and horizontally in the X-Y plane of the sheet. In this embodiment, the rows 1110 represent odd rows of pillow members and the rows 1115 represent even rows of pillow members.

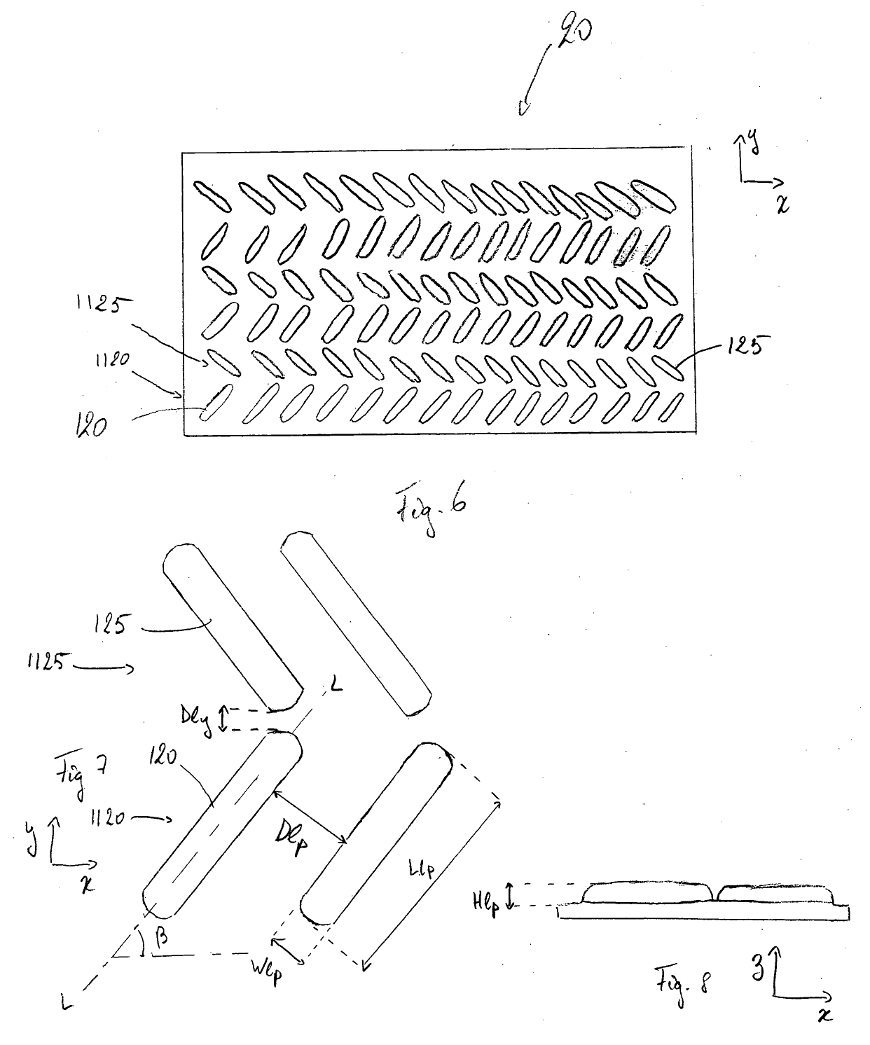

In one embodiment, schematically represented in FIG. 4, two consecutive rows 1110 and 1115 can be located on the sheet such that the pillow members 115 of the second row 1115 are offset relative to the pillow members 110 of the first row 110 (i.e., not aligned along the Y axis). FIG. 5 is a close-up top view where a plurality of pillow members are represented. The pillow members' arrangement on the sheet can be defined by distances Dpx, Dpy, Dt, and the angle α (or (AOB) (shown in FIG. 5). The distance Dpx is the closest distance between two consecutive pillow members in the same row (i.e., along the X-axis), the distance Dpy is the closest distance between two consecutive pillow members of two rows, where these two consecutive pillow members are substantially aligned along the Y axis, and the distance Dt is the closest orthogonal distance between two closest pillow members in consecutive rows. The angle α (or AOB) is the angle defined by a line drawn from the centroid of three adjacent pillow members in the X and Y axis (shown as points A, 0 and B in FIG. 5) where pillow members A and B are the endpoints and O is the central point of the defined angle. In this embodiment, the angle α (or (AOB) as shown in FIG. 5) is between about 5 and about 85 degrees, preferably between about 30 and about 60 degrees and more preferably equal to about 45 degrees. One skilled in the art will understand that when rows of pillow members are offset it is possible to increase the number of pillow members 110 on a cleaning sheet and consequently, improve both the “cleaning efficiency” and the “cleaning efficacy” of the sheet. In one embodiment, the distance Dt between pillow members located on two consecutive rows 1110 and 1115, is comprised between about 0.1 and 20 mm, preferably between 0.5 and 10 mm and more preferably between 1.0 and 8 mm. In one embodiment, the pillow members 110 and/or 115 do not overlap (i.e., are separated to form a flow path 210). One skilled in the art will understand that the shape as well as the dimensions Lp, Wp, Dpx, Dpy and Dt can be chosen in order to prevent the pillow members 110 and/or 115 from overlapping. In one embodiment, a cleaning sheet 10 can have a plurality of pillow members 110 all having the same shape and/or the same Lp, Wp and Hp dimensions. In another embodiment, a cleaning sheet 10 can have a plurality of pillow members 110 having different shapes and/or Lp, Wp and Hp dimensions. For example, some pillow members of the sheet 10 can have a cross-sectional arch shape and others have a cross-sectional triangular shape, some pillow members of the sheet can be relatively large and others relatively small. In one embodiment, the distance Dpx between consecutive pillow members can gradually increase from the side edges to the center portion of the sheet. Conversely, the distance Dpx between consecutive pillow members can gradually decrease from the edges to the center portion of the sheet. In one embodiment, a cleaning sheet 10 can have a plurality of pillow members 110 forming a plurality of rows and such that the distance Dt between each pair of consecutive rows is substantially identical. In another embodiment, a cleaning sheet 10 can have a plurality of pillow members 110 forming a plurality of rows such that the distance Dt between the first and the second row is smaller than the distance Dt between the second and the third row. In one embodiment, the distance Dt between consecutive rows can gradually increase from the edges to the middle portion of the sheet. Conversely, the distance Dt between consecutive rows can gradually decrease from the edges to the middle portion of the sheet.

Among other benefits, the three-dimensional nature of each pillow member as well as the open space in between each pillow member create a “flow path” 210 for the dust/particles when the cleaning sheet is used to clean a hard surface.

It has been observed that during the typical cleaning operation of a hard surface with a standard cleaning sheet attached to a cleaning implement, different types of particles having various sizes tend to accumulate on a portion adjacent to the edges of the mop head and do not have the opportunity to reach the middle portion of the cleaning sheet. Without intending to be bound by any theory, it is believed that providing a cleaning sheet with a “flow path” allows the particles to reach the middle portion of the sheet. As a result, a larger portion of the cleaning sheet is used and more particles are trapped, thus its cleaning efficiency and efficacy is increased. When the cleaning sheet having a plurality of pillow members and a “flow path” is used to clean a surface, the dust/particles first tend to accumulate on the portion of the sheet adjacent the leading edge of the mop head. However, within a relatively short period of time, this aggregate of particles tend to weaken as the particles keeps accumulating until the aggregate eventually breaks apart. When this aggregate of particles breaks apart, the particles are then free “to flow” within the “flow path” until they encounter a pillow member (closer to the middle portion of the sheet) which traps these particles. As a result, the front and back leading edge portions of the sheet can be viewed as “self-cleaning”. This phenomenon is even more apparent during a typical cleaning operation. It has been observed that when a user cleans a hard surface with a sheet attached to an implement, the pressure applied to the handle, and consequently, on the cleaning sheet, is not constant. In addition, a user often moves/rotates the mop head (via a rotation of the handle) to clean a different area or to avoid objects on the floor surface. The user typically applies less pressure during these rotations. These variations in pressure and direction over time weakens the aggregate of particles which tend to break apart rapidly and, as a result, increases the flow of particles towards the middle portion of the sheet. In addition, it has been observed that when a cleaning sheet which includes on at least one of its outer surfaces, a three-dimensional pattern with “flow paths”, is used to clean a hard surface, larger particulates are no longer pushed in front of the mop head but are trapped in the “large” flow paths (or three-dimensional channels) within the middle portion of the sheet (i.e., away from the front and back leading edges of the sheet). Such a cleaning sheet reduces the amount of soil and larger particles left behind during the mopping operation.

Among other benefits, a cleaning sheet 10 having a plurality of pillow members 110 defining a flow path 210 improves the cleaning efficacy of the sheet by allowing the dust/particles “to travel” further towards the middle portion of the cleaning sheet during the cleaning operation. It is also believed that a cleaning sheet having a plurality of rows 1110 where the pillow members of a row are offset relative to the pillow members located on the preceding and subsequent row, is even more beneficial as the flow path 210 is relatively sinuous which increases the probability that particles “flowing” within the flow paths, will encounter a pillow member 110.

In another embodiment represented in FIG. 6 one of the outer surfaces of a cleaning sheet 20 comprises a three-dimensional texture or pattern defined by a plurality of longitudinal pillow members 120 extending outwardly.

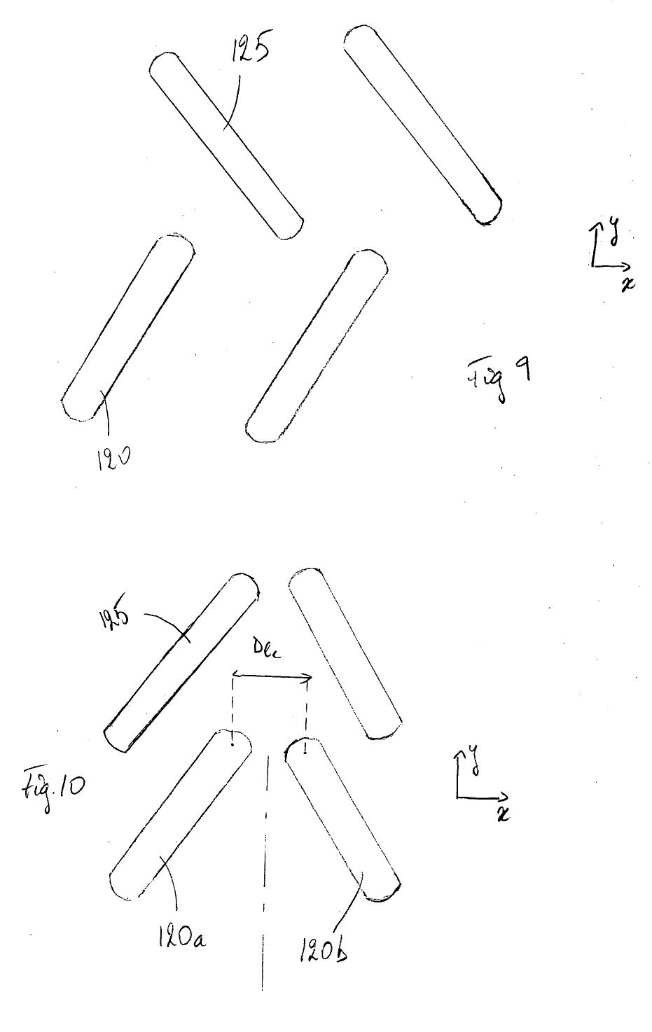

FIGS. 7 and 8 are close-up views where a plurality of longitudinal pillow members 120 are represented. A longitudinal pillow member 120 can be defined by its length Llp, its width Wlp and its height Hlp (shown in FIGS. 7 and 8). The pillow members' arrangement on the sheet can be defined by distances Dlp, Dly, and the angle β (shown in FIG. 7). The distance Dlp is the closest distance between two consecutive longitudinal pillow members 120 of a same row, The distance Dly is the closest distance between two consecutive longitudinal pillow members 120 of two rows, where these two consecutive pillow members are substantially aligned along the Y axis, and angle β is the angle between the longitudinal axis L-L of the pillow members and the leading edge of the sheet. In one embodiment, Llp is between about 3 and 250 mm, preferably between 4 and 175 mm, more preferably between 5 and 75 mm, its width Wlp is between about 1 and 50 mm, preferably between about 2 and 40 mm, more preferably between about 3 and 30 and Hlp is between about 0.5 and 12 mm, preferably between about 0.75 and 10 mm, more preferably between about 0.9 and 9 mm. In one embodiment, a linear pillow member can be such that one of the Llp, Wlp or Hlp dimension is constant and either one of the other dimensions, or both, vary increasingly or decreasingly. For example, the length Llp and width Wlp can be fixed and the height Hlp can vary. In one embodiment, a longitudinal pillow member 120 can be located on the cleaning sheet such that the angle β is between about 10 and about 170 degrees, preferably between about 20 and about 160 degrees and more preferably between about 30 and about 150 degrees, even more preferably about 45 or 135 degrees.

In one embodiment, a plurality of pillow members 120 can be created on at least one of the outer surfaces of the cleaning sheet 20 in order to obtain rows or lines 1120 of longitudinal pillow members as shown in FIG. 6. In one embodiment, the longitudinal axes of two consecutive longitudinal pillow members can be substantially parallel such that the two longitudinal pillow members define a flow path 220. In one embodiment, the distance Dlp is between about 0.1 and about 20 mm, preferably between about 0.5 and about 10 mm, more preferably between about 1 and 8 mm. One skilled in the art will understand that the height Hlp and the distance Dlp (the closest distance between two consecutive longitudinal pillow members) provides also the height and the width of a flow path which can be used by dust/particles to move towards the middle portion of the sheet 20.

In one embodiment, the distance Dly between pillow members located on two consecutive rows 1120 and 1125, is comprised between about 0 and 20 mm, preferably between 0 and 10 mm and more preferably between 0 and 8 mm. In this embodiment, the rows 1120 represent odd rows of longitudinal pillow members and the rows 1125 represent even rows of longitudinal pillow members.

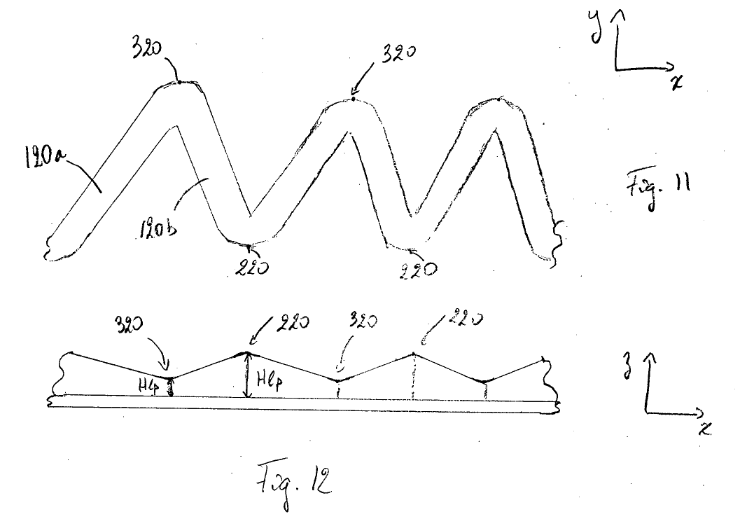

In one embodiment, a three-dimensional pattern can be created on sheet 20 such that the pattern comprises a plurality of rows 1120. In one embodiment shown in FIG. 6, a sheet 20 comprises a first row 1120 having a plurality of longitudinal pillow members 120 oriented in the same direction (i.e., having the same angle β to the front edge of the sheet) and a second row 1125 having longitudinal pillow members 125 oriented such that the pillow members 125 are the mirror image of the pillow members 120 relative to the length of the sheet as shown in FIGS. 6 and 7 (i.e., the longitudinal axes of the pillow members 125 to the front edge of the sheet is equal to about 180-β degrees). In one embodiment, a first row 1120 having a plurality of longitudinal pillow members 120 oriented in the same direction (i.e., having the same angle β to the front edge of the sheet) and a second row 1125 having longitudinal pillow members 125 oriented such that the pillow members 125 are oriented in a different angle than angle β (as previously described). In one embodiment, for any two consecutive rows of longitudinal pillow members, the pillow members 125 of the second row 1125 are the mirror image of the pillow members 120 of the first row 1120 relative to the length of the sheet. In a preferred embodiment shown in FIG. 9, the pillow members 125 are offset relative to the pillow members 120 of the row 1120.

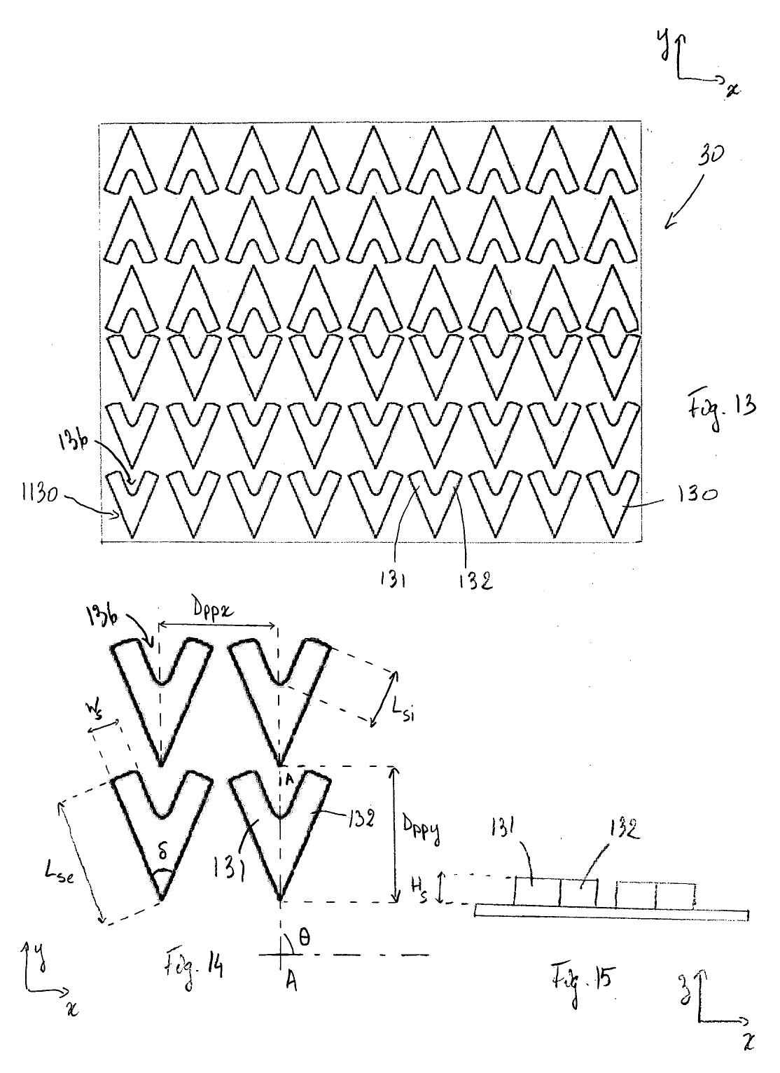

In one embodiment shown in FIG. 10, a three-dimensional texture or pattern can be created on at least one of the outer surfaces of a sheet 20 such that for any two consecutive longitudinal pillow members 120a and 120b of a given row 1120, the second longitudinal pillow member 120b is the mirror image of the first longitudinal pillow member 120a relative to the width of the sheet 20. In one embodiment, the distance Dlc between the two converging ends of two consecutive longitudinal pillow members 120a and 120b is between about 0 and about 20 mm, preferably between about 0 and about 15 mm. In this embodiment, when the distance Dlc is substantially equal to 0, the longitudinal pillow members 120 form a “zigzag” pattern. In this embodiment, which is shown in FIGS. 11 and 12, for any given “zigzag” row of pillow members, the height Hlp at the tips 220 (pointing towards the leading or trailing edge of the sheet) is preferably greater than the height Hlp at the tips 320 (pointing towards the middle portion of the sheet) in order to provide a flow path to the dust/particles towards the middle portion of the sheet. In a preferred embodiment, the height Hlp at the tips 320 is equal to about 0 mm.

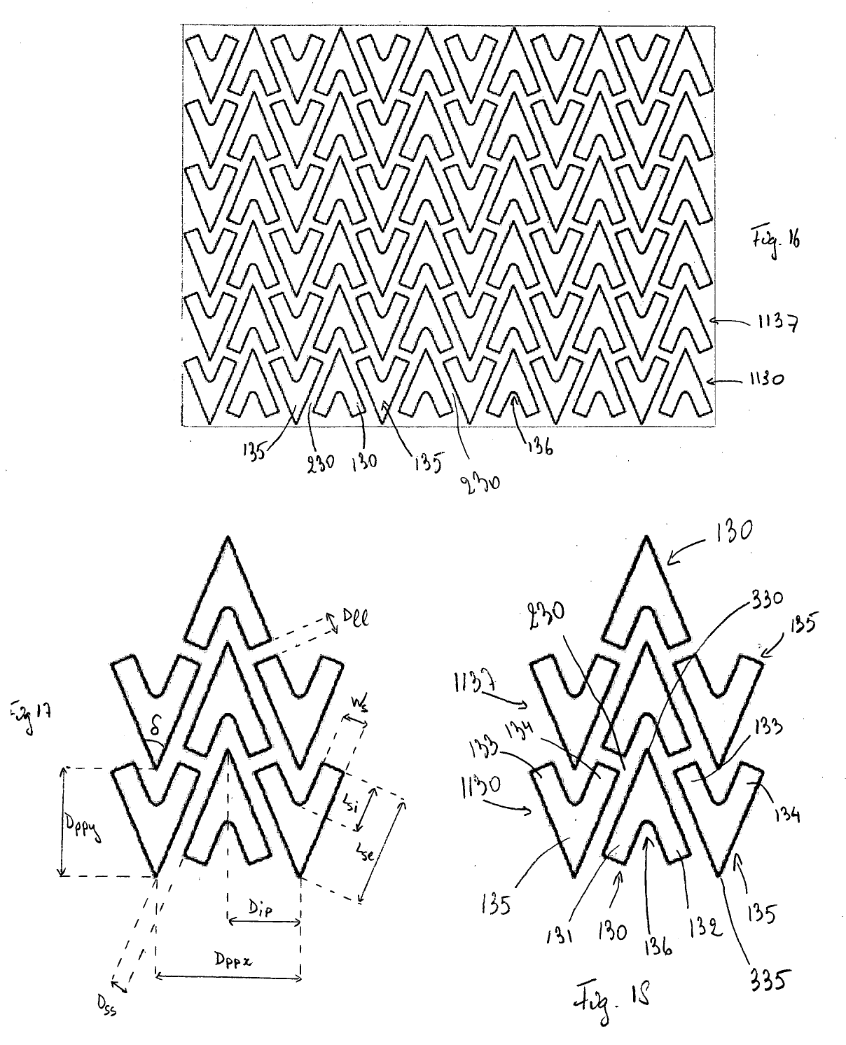

In another embodiment shown in FIG. 13, one of the outer surfaces of a cleaning sheet 30 comprises a three-dimensional texture or pattern defined by a plurality of V shaped (or chevron) pillow members 130 extending outwardly.

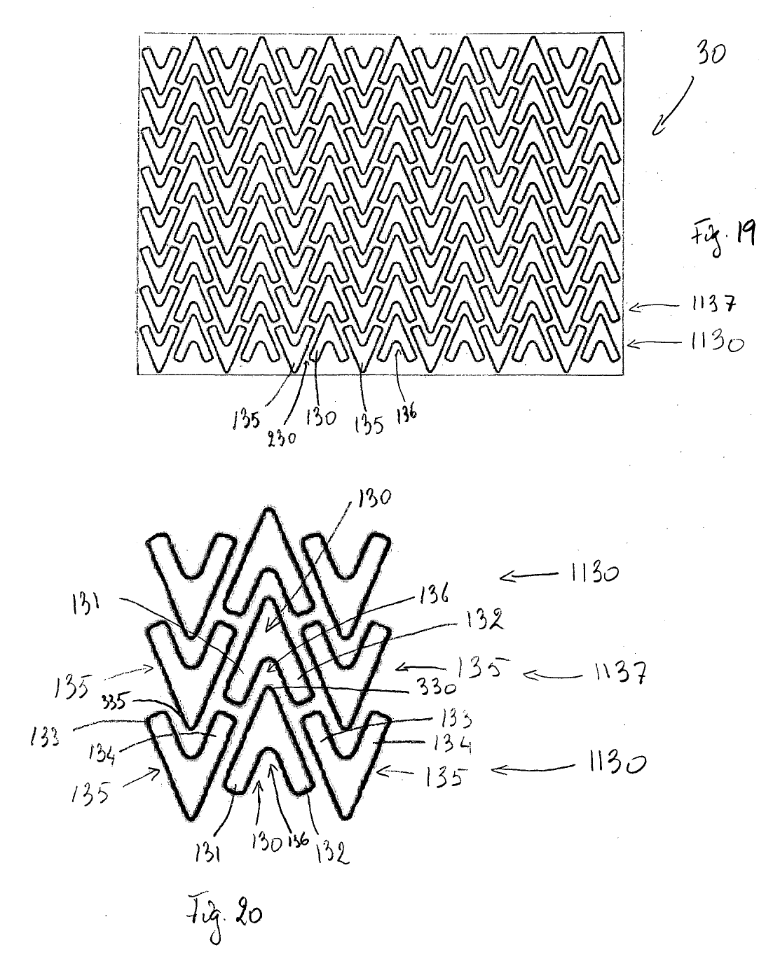

FIGS. 14 and 15 are close-up views where a plurality of V-shaped pillow members are represented. A V-shaped pillow member 130 comprises a first and a second longitudinal segment 131 and 132, which can be defined by their length Lse (corresponding to the exterior length of the segments) and Lsi (corresponding to the interior length of the segments), their width Ws, their height Hs and the closed angle δ between the first and the second segments 131 and 132. Among other benefits, the first and second longitudinal segments 131 and 132, by converging to a common point, form a “pocket” 136 capable of trapping dust/particles and in particular relatively large particles (between about 1 and 10 mm in diameter) which get entangled with the free-fibers of the segments 131 and 132. In one embodiment, the Lse, Lsi, Ws and Hs dimensions of both segments 131 and 132 are substantially equal as shown in FIGS. 14 and 15. In one embodiment, Lse is between about 3 and 75 mm, preferably between 4 mm and 60 mm, more preferably between 5 and 40, Lsi is between about 2.5 mm and 74.5 mm, preferably between 3.5 mm and 59.5 mm, more preferably between 4.5 mm and 39.5 mm, Ws is between about 0.5 mm and 20 mm, preferably between about 0.75 mm and 15 mm, more preferably between about 1.0 mm and 10 mm, Hs is between about 0.50 mm and 12 mm, preferably between about 0.75 mm and 10 mm, more preferably between about 0.90 mm and 9 mm and δ is between about 5 and about 175 degrees, preferably between 5 and 120 degrees and more preferably between 5 and 75 degrees. In another embodiment, one or more of the Lse, Lsi, Ws and Hs dimensions of the first segment 131 can differ from the Lse, Lsi, Ws and Hs dimensions of the second segment 132. In one embodiment, one or two of the Ls, Ws or Hs dimensions can be constant and the others vary. For example, the Ls and Ws dimensions can be constant and the Hs dimension can gradually increase or decrease between the tip of the pillow members 130 and the ends of the longitudinal segments 131, 132. In one embodiment, the Hs dimension can gradually decrease between the tip of the pillow member 130 and the ends of the longitudinal segments 131, 132, from about 12 mm to about 0 mm, preferably from about 10 mm to about 0.50 mm, more preferably from about 9 mm to about 0.75 mm.

In one embodiment also shown in FIGS. 13 through 15, a V-shape pillow member 130 can be located on the cleaning sheet such that the angle 0 between the symmetrical axis A-A of each V-shape pillow member and the leading edge of the sheet is between about 5 and 175 degrees, preferably between 30 and 150 degrees, more preferably between 60 and 120 degrees and even more preferably is about 90 degrees. FIG. 15 is a side elevational view of the sheet 30 having V-shape pillow members 130 shown in FIG. 14.

In one embodiment, a plurality of V-shaped pillow members 130 can be created on at least one of the outer surfaces of the cleaning sheet 30 in order to obtain rows or lines 1130 of V-shape pillow members as shown in FIGS. 13 and 14. In one embodiment, all the V-shape pillow members of a row 1130 can be oriented in (or pointing towards) the same direction. In a preferred embodiment, the V-shape pillow members are arranged on the cleaning sheet 30 such that the pillow members of a first half of the cleaning sheet 30 (along the Y axis) all point towards the same direction, preferably toward the front edge of the sheet 30, and the V-shape pillow members of the second half of the sheet 300 all point toward the opposite direction, i.e., towards the back edge of the sheet 30. The pillow members 130 can be further defined by the distance Dppx between the apexes of two consecutive pillow members on the X axis and by the distance Dppy between the apexes of two adjacent pillow members located on two consecutive rows on the Y axis. In one embodiment, Dppx is between about 9 and 225 mm, preferably between 12 mm and 180 mm, more preferably between 15 mm and 120 mm and Dppy is between about 1.0 mm and 150 mm, preferably between about 1.5 mm and 120 mm and more preferably between 2.0 mm and 80 mm.

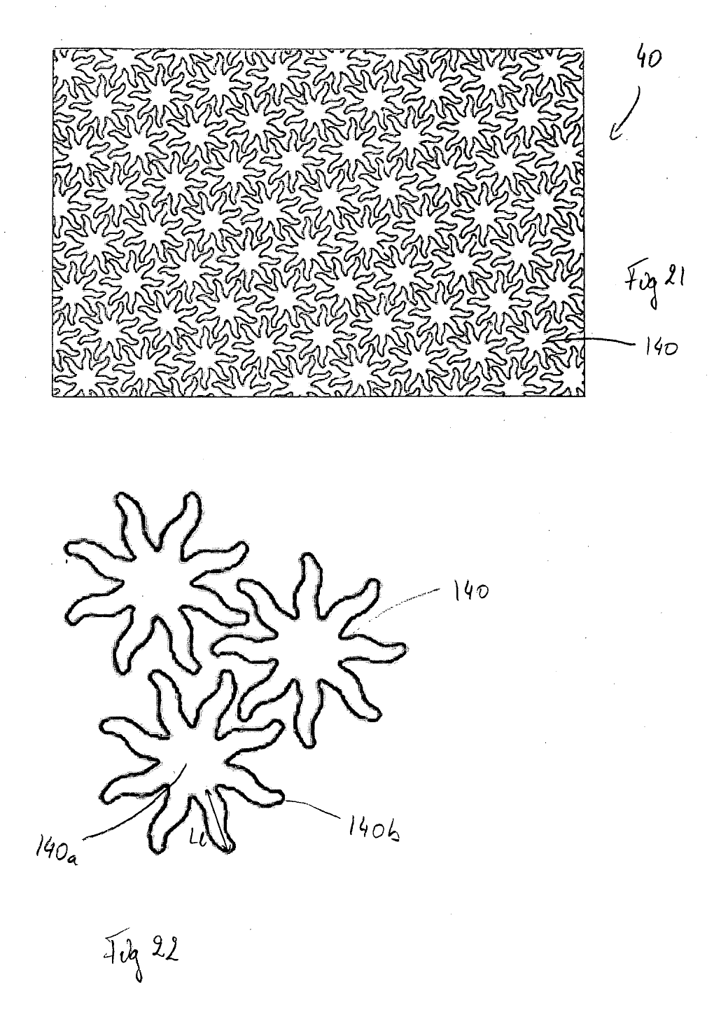

In a preferred embodiment, two consecutive V-shape pillow members 130 and 135 of a same row, point towards opposite directions as shown in FIGS. 16 through 18. In this embodiment, the pillow members can be characterized by their Lse, Lsi, Ws, Hs, δ, Dppx and Dppy dimensions but also by the distance Dip between the exterior apexes 330 and 335 of two pillow members 130 and 135 on the X axis (shown in FIGS. 17 and 18), the distance Dss between longitudinal segments 132 and 133 and/or 131 and 134 of two consecutive pillow members of a same row (i.e., channel width) and the distance Dll between a pillow member 130 of a first row and the pillow member 135 of the next or previous row (all the foregoing distances are shown in FIG. 17). In one embodiment, Dip is between about 1.5 mm and about 40 mm, preferably between about 2 mm and 25 mm, more preferably between about 2.5 mm and about 12.5 mm, Dss is between about 0.1 mm and about 20 mm, preferably between about 0.5 mm and 10 mm, more preferably between about 1 mm and about 8 mm and Dll is between about 0.1 mm and about 20 mm, preferably between about 0.5 mm and 10 mm, more preferably between about 1 mm and about 8 mm.

In this one embodiment, two consecutive V-shape pillow members provide a flow path 230 for dust/particles as previously discussed. Among other benefits, alternating the directions of consecutive V-shape pillow members not only allows a portion of the dust/particles to be trapped by the “pocket” 136 and segments 131, 132 of the V-shape pillow members 130 (which are pointing towards the middle portion of the sheet) and by the segments 133, 134 of the V-shape pillow members 135 (which are pointing towards the front or back leading edges of the sheet) but also, it allows for the portion of the particles which has not been trapped, to flow within the flow path 230 and reach the next row 1137. In this embodiment, the rows 1130 represent odd rows of V-shape pillow members and the rows 1137 represent even rows of V-shape pillow members. Without intending to be bound by any theory, it is believed that the exterior apex portion of the V-shape pillow members 135, deflects a portion of particles such that there are forced to enter the flow path 230. Once the particles reach the subsequent or second row 1137, there are predominantly directed towards the “pocket” 136 of a V-shape pillow member 130 of the second row 1137.

When the hard surface to be cleaned is covered with a large amount of dust/particles, the “pockets” 136 of the V-shape pillow members 130 of the first row 1130 can get “filled” rapidly. In addition, dust/particles may also tend to agglomerate in the portion of the sheet adjacent the front and back leading edges of the mop head. After this agglomerate of particles reaches a critical mass, it breaks apart and a portion of the untrapped particles flow within the flow path 230. As a result, the first row of V-shape pillow members 1130 is capable of “trapping” more particles afterwards. Moreover, as previously discussed, it has also been observed that during a typical cleaning operation, the amount of pressure applied to the sheet as well as the orientation of the mop head varies. These variations weaken the agglomerated particles which consequently, tend to break apart more rapidly allowing to particles to flow within the flow path 230 and to reach the subsequent rows of V-shape pillow members.

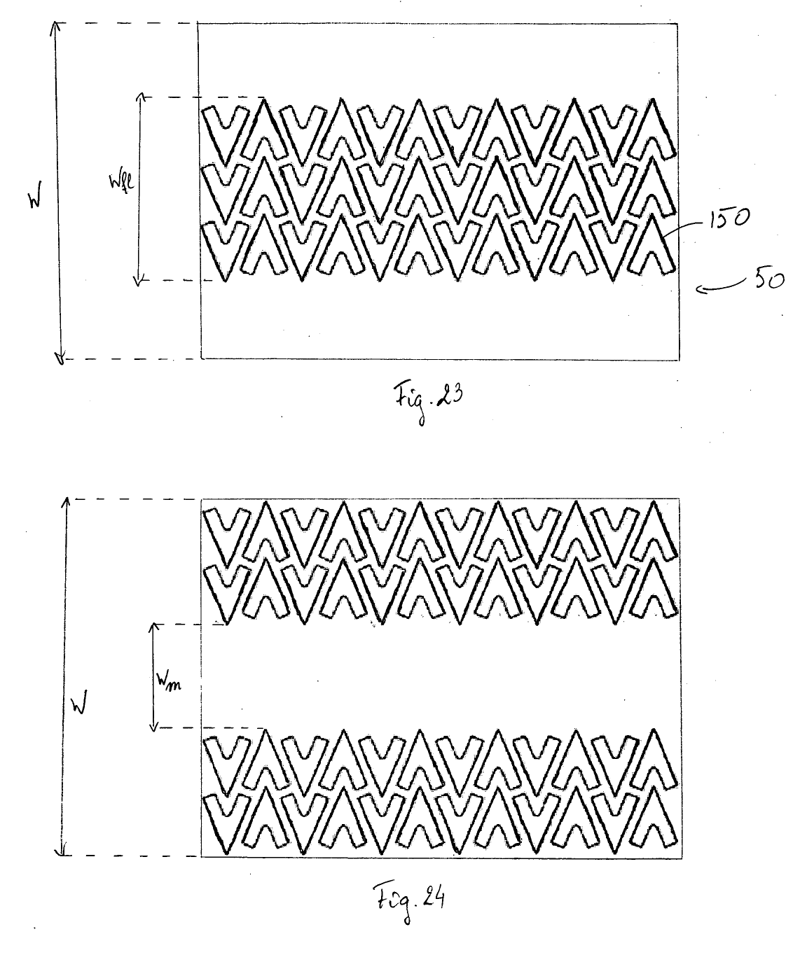

In another embodiment, a three-dimensional pattern including V-shape pillow members 130 can be created on at least one of the outer surfaces of the cleaning sheet 30 such that the exterior apex 330 of the V-shape pillow members 130 of the first row 1130 can be located within the area defined by the segments 131, 132 of the adjacent V-shape pillow members 130 of the second row 1137 as shown in FIGS. 19 and 20. Likewise, the exterior apex 335 of the V-shape pillow members 135 of the second row 1137 can be located within the area defined by the segments 133, 134 of the V-shape pillow members 135 of the first row 1130.

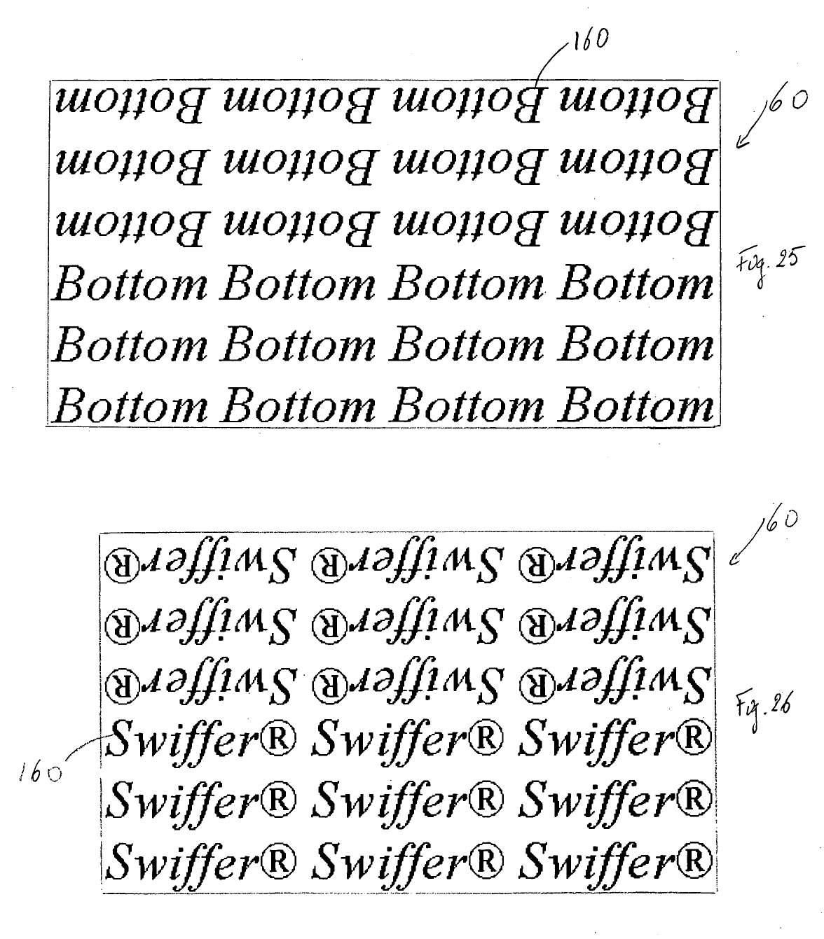

In another embodiment, shown in FIG. 21, one of the outer surfaces of a cleaning sheet 40 comprises a three-dimensional texture or pattern defined by a plurality of “octopus” shape pillow members 140 extending outwardly.

FIG. 22 is a close-up view where a plurality of “octopus-shape” pillow members 140 are represented. An “octopus-shape” pillow member 140 comprises a center portion 140a and a least one, but preferably a plurality of “leg” portions 140b extending radially from the center portion 140a. In one embodiment, an “octopus-shape” pillow member 140 has between about 1 and about 12, preferably between about 4 and about 8 “leg” portions 140b. In one embodiment, the center portion 140a has a substantially disk shape having a radius of at least about 1 mm, preferably at least about 2 mm. In one embodiment, the center portion 140a has a radius between about 0.5 and about 12 mm, preferably between about 0.5 and about 8 mm, more preferably between about 1 and about 5 mm. In one embodiment, a “leg” portion 140b has a length L1 (which is the distance from the periphery of the central disk to the furthest point on radial leg) of at least about 2 mm, preferably at least about 4 mm. In one embodiment, a “leg” portion 140b has a length L1 between about 2 mm and about 12 mm, preferably between about 4 mm and about 10 mm. In one embodiment, the “leg” portions 140b can be substantially straight. In another embodiment, the “leg” portions 140b can be “oscillating” radially. In one embodiment, a cleaning sheet 40 comprises a plurality of “octopus-shape” pillow members 140 on at least one of its outer surfaces.

One skilled in the art will understand that a wide variety of three-dimensional patterns can be created on at least one of the outer surfaces of a cleaning sheet and still provide the same benefits. One skilled in the art will also understand that it is possible to combine different three-dimensional patterns having different sizes or shapes and still provide the same benefits. Non-limiting examples of three-dimensional patterns include, M-shape, N-shape, W-shape, X-shape, Y-shape or any combinations thereof. Additionally, one skilled in the art will understand that the three-dimensional patterns can be curved inwardly or outwardly (i.e., parabolically or hyperbolically) and still provide the same benefits.

In one embodiment, a cleaning sheet comprises an even number of rows of pillow members. In another embodiment, a cleaning sheet comprises an odd number of rows of pillow members.

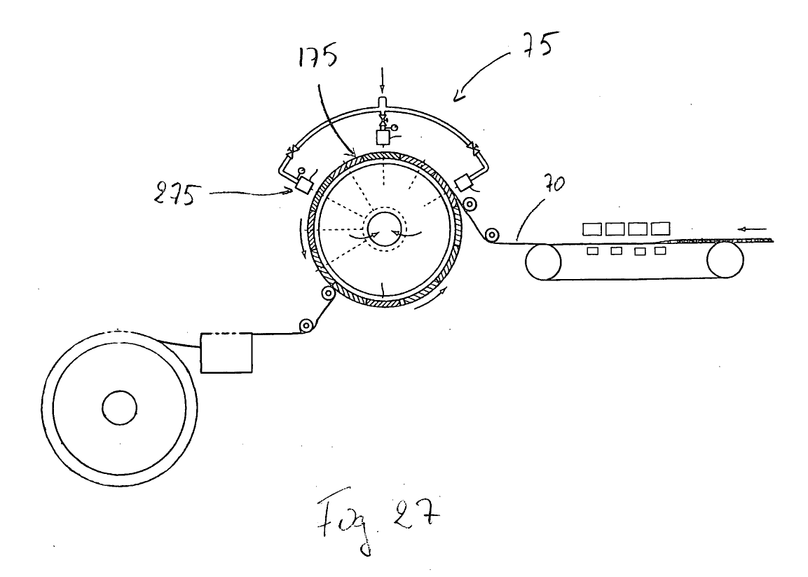

In one embodiment shown in FIG. 23, only a portion of at least one of the outer surfaces of a cleaning sheet comprises pillow members. In one embodiment, a cleaning sheet 50 has a plurality of rows of pillow members 150 on at least one of its outer surfaces such that the distance Wfl between the first row and the last row of pillow members on the sheet is less than about 90%, preferably less than about 75% and more preferably less than about 60%, even more preferably less than about 30% of the total width W of the cleaning sheet. In one embodiment shown in FIG. 23, a plurality of rows of pillow members 150 are located substantially in the middle portion of the cleaning sheet 150.

In another embodiment shown in FIG. 24, a plurality of rows of pillow members 150 are located on at least one of the outer surfaces of a cleaning sheet 50 such that the middle portion of the sheet 50 does not have any pillow members 150. In one embodiment, the width Wm of the middle portion of the sheet which does not have any pillow members 150 is at least about 10%, preferably at least about 25%, more preferably at least about 33% and most preferably at least about 50% of the total width W of the cleaning sheet 50.

The cleaning sheets 50 represented in FIGS. 23 and 24 comprise V-shape pillow members but one skilled in the art will understand that any other shape of pillow members will provide the same benefits.

In one embodiment, the portion(s) of the sheet which does not have any pillow members 150 can be coated with an additive and/or comprise instructions, logos and/or a trademark which can be directly printed on these portion(s).

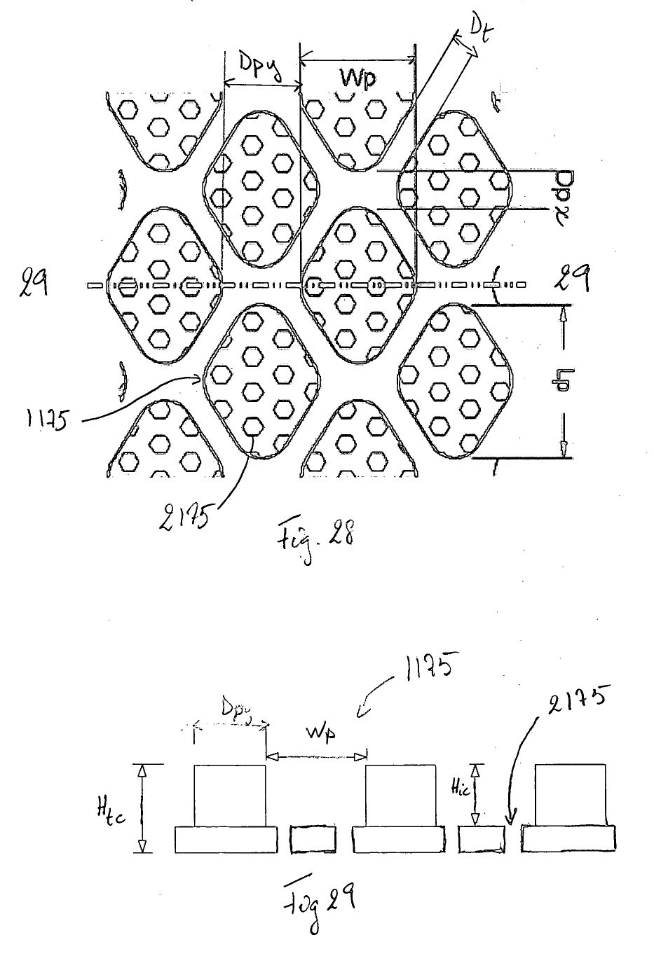

In one embodiment shown in FIGS. 25 and 26, at least one of the outer layers of a cleaning sheet 60 comprises a three-dimensional pattern created by at least one, but preferably a plurality of pillow members 160 which can convey information and/or instructions to the user. In one embodiment, at least one pillow member 160 can be a logo and/or a trademark, which in addition to provide cleaning benefits as previously discussed, inform the user of the “origin” of the cleaning sheet. In one embodiment, at least one pillow member 160, but preferably a plurality of pillow members 160, provide and convey instructions to the consumer, for example in the form of word(s). These instructions can explain to the user how to use and/or attach the cleaning sheet 60. In one embodiment, a plurality of pillow members 160 can be created on one of the outer surfaces of the cleaning sheet 60 such that at least one word, preferably one word selected from the group consisting of “bottom”, “top”, “down”, “up”, “floor”, “surface”, and any combinations thereof, are visible by a user when the user is looking at the outer surface having this or these word(s). Among other benefits, a cleaning sheet having pillow members providing instructions to the user, provides similar cleaning benefits than the cleaning sheets previously discussed but also allows the user to understand how to properly/optimally use the sheet. This can be the case, for example, when the pillow members are all located on one of the outer surfaces of the sheet. These instructions formed by the pillow members 160 are also beneficial when a first outer surface of the sheet is coated with an additive and the second outer surface is not or when both outer surfaces are coated with additives which can have different benefits/properties. In order to provide all its cleaning benefits, such a cleaning sheet should be used and/or attached to a mop head such that the pillow members extend towards the surface to be cleaned.

III. Method to Make a Cleaning Sheet with a Three-Dimensional Pattern.

The cleaning sheets described herein can be made using either a woven or nonwoven substrate(s) via several processes. Non-limiting example of processes suitable to make the cleaning sheets include forming operations using melted materials laid down on forms, especially in belts, forming operations involving mechanical actions/modifications carried out on films, imaging/patterning process involving an imaging device having a drum with an imaging surface and/or by embossing operations and combinations thereof. The substrates used for the cleaning sheet with pillow members can made by any number of methods (e.g., hydroentangled, spunbonded, meltblown, carded resin bonded, carded through air-bonded, carded thermal bonded, air laid, etc.), once the essential three dimensional dimensions and basis weight requirements are determined. However, the preferred substrates are nonwoven, and especially those formed by hydroentanglement as is well known in the art, since they provide highly desirable open fibrous structures. Therefore, preferred cleaning sheets are nonwoven substrates having the characteristics described herein. Materials particularly suitable for forming the preferred nonwoven cleaning sheet of the present invention include, for example, natural cellulosics as well as synthetics such as polyolefins (e.g., polyethylene and polypropylene), polyesters, polyamides, synthetic cellulosics (e.g., RAYON®), and blends thereof. Also useful are natural fibers, such as cotton or blends thereof and those derived from various cellulosic sources. Preferred starting materials for making the hydroentangled fibrous sheets are synthetic materials, which may be in the form of carded, spunbonded, meltblown, airlaid, or other structures. Particularly preferred are polyesters, especially carded polyester fibers. The degree of hydrophobicity or hydrophilicity of the fibers is optimized depending upon the desired goal of the sheet, either in terms of type of soil to be removed, the type of additive that is provided, when an additive is present, biodegradability, availability, and combinations of such considerations. In general, the more biodegradable materials are hydrophilic, but the more effective materials tend to be hydrophobic.

The cleaning sheets may be formed from a single fibrous layer, but preferably are a composite of at least two separate layers. Preferably, the sheets are nonwovens made via a hydroentangling process. In this regard, prior to hydroentangling discrete layers of fibers, it may be desired to slightly entangle each of the layers prior to joining the layers by entanglement.

The cleaning sheets described herein can have a basis weight of at least about 40 g/m², preferably between about 50 g/m² and 90 g/m², more preferably between about 55 g/m² and about 80 g/m².

Non-limiting examples of suitable cleaning sheets can be made as follows:

### EXAMPLE 1

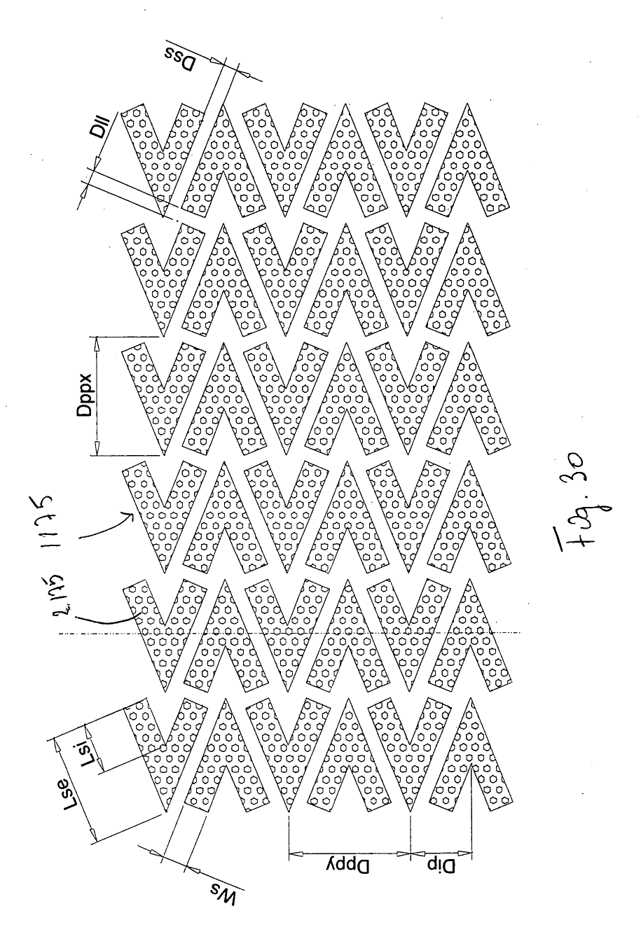

A cleaning sheet having a three-dimensional pattern on one of its outer surfaces having a plurality of pillow members with the following dimensions Lp is equal to about 9.4 mm, Wp is equal to about 6.8 mm, Hp is equal to about 1.6 mm, Dpx is equal to about 4.8 mm, Dpy is equal to about 2.4 mm, Dt is equal to about 1.5 mm, alpha is equal to about 45 degrees and can be made via the following process which is represented in FIG. 27.

A first layer of carded web having a basis weight of about 26.5 g/m² and comprising polyester staple fibers having the following characteristics, 37 mm length and 1.5 dpf (available from Wellman, Inc. as Type 203 fibers) is applied on a layer of a polypropylene spunbond web having a basis weight of about 15 g/m². These two layers are then subjected to hydroentangling in order to form a dual layer web. The resulting dual layer web is then dried to form a precursor web. A second layer of carded web having a basis weight of about 26.5 g/m² and comprising polyester staple fibers having the following characteristics, 37 mm length and 1.5 dpf (available from Wellman Fiber as Type 203 fibers) is then applied on the precursor web such that the spunbond web layer is “sandwiched” between the first and second layers of carded web and again subjected to hydroentangling. The resulting tri-laminate web 70, which has a total basis weight of about 68 μm², is then further subjected to hydraulic imaging/patterning by an imaging device 75 as described in U.S. Pat. No. 6,502,288 to Black et al., issued Jan. 7, 2003, U.S. Patent application serial No. US20030019088, to Carter, published Jan. 30, 2003, International patent application serial No. WO 02/46509, to Black et al., published Jun. 13, 2002, and International patent application serial No. WO 02/058006, to Carter et al., published Jul. 25, 2002, all assigned to Polymer Group Inc. This imaging device 75 comprises an imaging/patterning drum 175. The imaging device comprises a moveable imaging surface which can move relative to a plurality of entangling manifolds 275 which act in cooperation with three-dimensional cavities defined by the imaging surface of the image transfer device 75 to effect imaging and patterning to the tri-laminate. A top view of the imaging surface of the drum 175 used to “create” the previously described pillow members, is represented in FIG. 28. The imaging surface of the drum 175 comprises a plurality of cavities 1175 which include drain holes 2175 at the bottom surface to evacuate water of the hydroentanglement process. One skilled in the art will understand that the Lp, Wp, Dt, Dpx and Dpy dimensions of the pillow members obtained on the cleaning sheet are substantially the same as the corresponding Lp, Wp, Dt, Dpx and Dpy dimensions of the cavities (or “images”) seen from the top surface of the drum 175.

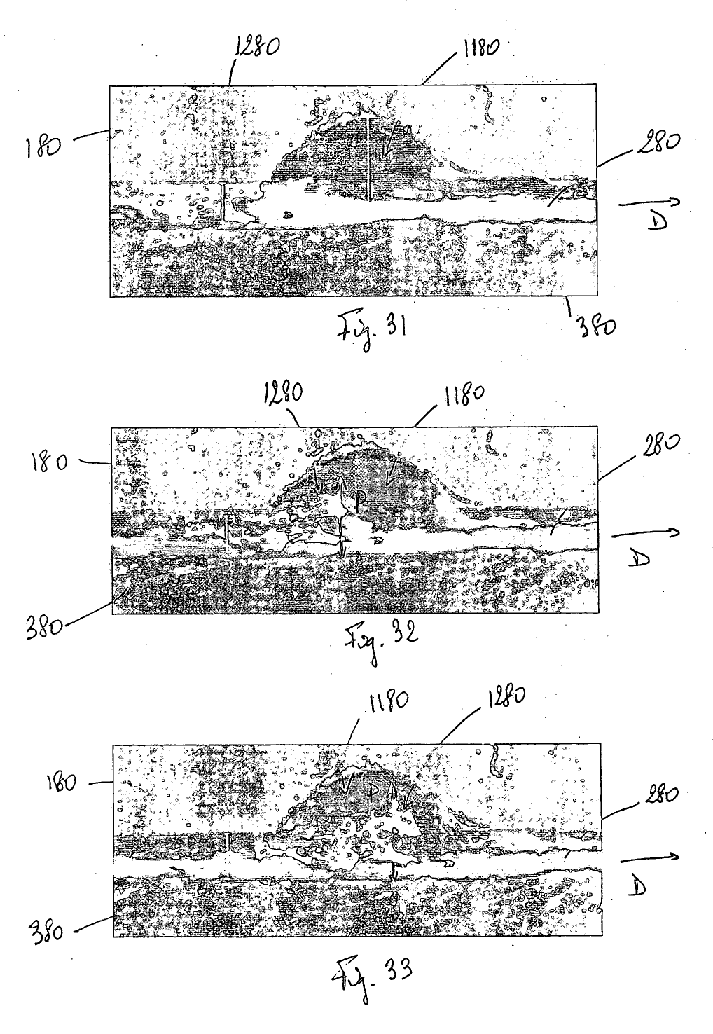

During the imaging/patterning process, the tri-laminate web 70 is hydraulically impinged on the imaging surface of the drum 175 and some of the fibers of at least one of the carded webs are pushed and drawn (i.e., to expand) within the cavities 1175 of the drum 175 to form the pillow members. FIG. 29 shows a cross-sectional view of the imaging drum along the line 29-29 where Hic represents the “inner depth” of a cavity 1175 and Htc represents the thickness of the imaging drum 175. The resulting imaged/patterned web is subsequently dried and cut to appropriate dimensions to form the cleaning sheets.

### EXAMPLE 2

A cleaning sheet having a plurality of pillow members with the following dimensions Lp is equal to about 9.4 mm, Wp is equal to about 6.8 mm, Hp is equal to about 1.6 mm, Dpx is equal to about 2.4 mm, Dpy is equal to about 4.8 mm, Dt is equal to about 1.5 mm, alpha is equal to about 45 degrees and forming a three-dimensional pattern in one of the outer surfaces of the cleaning sheet can be made via the following process.

A first layer of carded web having a basis weight of about 58 g/m² and comprising polyester staple fibers having the following characteristics, 37 mm length and 1.5 dpf (available from Wellman, Inc. as Type 203 fibers) is applied on a layer of a polypropylene spunbond web having a basis weight of about 10 g/m². These two layers are then subjected to hydroentangling in order to form a dual layer web. The resulting dual layer web which has a basis weight of about 68 g/m² is then further subjected to hydraulic imaging/patterning by an imaging device as previously discussed. The resulting imaged/patterned web is subsequently dried and cut to appropriate dimensions to form the cleaning sheets.

### EXAMPLE 3

A cleaning sheet having a plurality of V-shape pillow members with the following dimensions: Lse is equal to about 19.9 mm, Lsi is equal to about 9 mm, Ws is equal to about 4.5 mm, Hp is equal to about 1.4 mm, y is equal to about 45 degrees, Dip is equal to about 11 mm, Dppy is equal to about 22, Dppx is equal to about 21 mm, Dll is equal to about 2.5 mm, and Dss is equal to about 2.5 mm (as shown in FIG. 17) and forming a three-dimensional pattern in one of the outer surfaces of the cleaning sheet can be made via the following process.

A first layer of carded web having a basis weight of about 29.2 g/m² and comprising polyester staple fibers having the following characteristics, 37 mm length and 1.5 dpf (available from Wellman, Inc. as Type 203 fibers) is applied on a layer of a polypropylene spunbond web having a basis weight of about 15 g/m². These two layers are then subjected to hydroentangling in order to form a dual layer web. The resulting dual layer web is then dried to form a precursor web. A second layer of carded web having a basis weight of about 23.8 g/m² and comprising polyester staple fibers having the following characteristics, 37 mm length and 1.5 dpf (available from Wellman, Inc. as Type 203 fibers) is then applied on the precursor web such that the spunbond web layer is “sandwiched” between the first and second layers of carded web and again subjected to hydroentangling. The resulting tri-laminate web, which has a total basis weight of about 68 g/m², is then further subjected to hydraulic imaging/patterning by an imaging device as previously discussed. A top view of the imaging surface of the drum 175 used to “create” the previously described V-shape pillow members, is represented in FIG. 30. The resulting imaged/patterned web is subsequently dried and cut to appropriate dimensions to form the cleaning sheets.

One skilled in the art will understand that the imaging surface of the drum can be viewed as the reverse image of the surface of the sheet carrying the pillow members (i.e. a pillow member on the sheet corresponds to a cavity on the imaging drum). Consequently, the dimensions of the image/pattern of the drum are substantially equal to the dimensions of the pillow members on the sheet in the X-Y plane and the depth of the cavities on the drum is at least equal to the height of the pillow members of the cleaning sheet.

IV. Cleaning Sheet During Typical Cleaning Operation.

As previously discussed, hard surfaces, in particular floor surfaces found in a house are rarely perfectly flat. When a floor surface includes ceramic tiles separated by grout lines, dust and other type of particulates tend to get lodged within the grout lines and are particularly difficult to remove depending on the depth of the grout lines. In addition, floor surfaces as well as other types of hard surfaces, can have relatively pronounced transition strips (e.g., strips or -joints of wood or metal found between rooms as well as baseboards).

A cleaning sheet which is substantially flat is not capable to reach deep into these grout lines and/or conform to the change in topography of the hard surface in order to dislodge and trap the particulates.

It is found that a cleaning sheet having a macroscopic three-dimensional pattern created by pillow members which are capable of recovering their original shape after having been compressed, is capable of conforming to the change in topography of a hard surfaces and, as a result, provides a higher cleaning performance.

In order to visualize the shape recovery and conformability of the sheet having pillow members to the change in topography of a surface, the following experiment is done.

A grout line 1180 of about 7 mm wide and about 2.5 mm deep is made along the width of the middle portion of the top surface of a first block 180 of PLEXIGLAS®. A cleaning sheet 280 comprising a macroscopic three-dimensional pattern created by pillow members 1280, such as the one described in Example 3 supra, is “sandwiched” between the first block of PLEXIGLAS® 180 and a substantially flat second block of PLEXIGLAS® 380 such that the side of the sheet comprising the pillow members is facing towards the surface of the first block 180 having the grout line 1180. The second block of PLEXIGLAS® 380 (simulating the bottom surface of a mop head) is pressed against the cleaning sheet 280 (i.e., towards the first block of PLEXIGLASS) such that the distance between the first and the second blocks is about 1 mm, in order to subject the cleaning sheet 280 to a compressive load of pressure of about 2 g/cm².

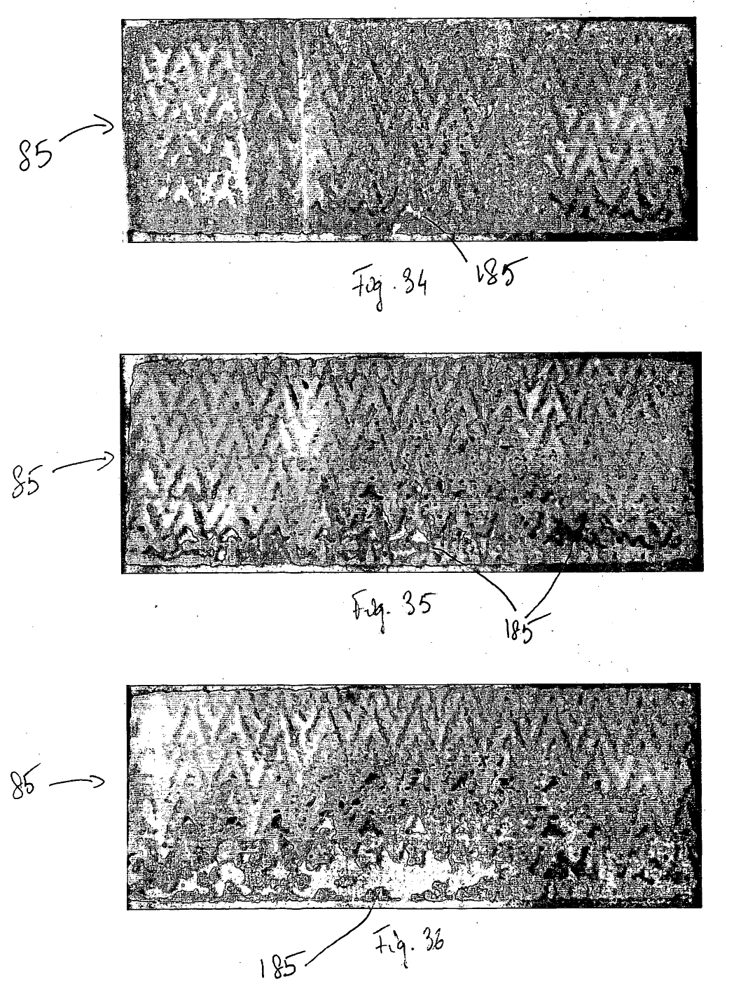

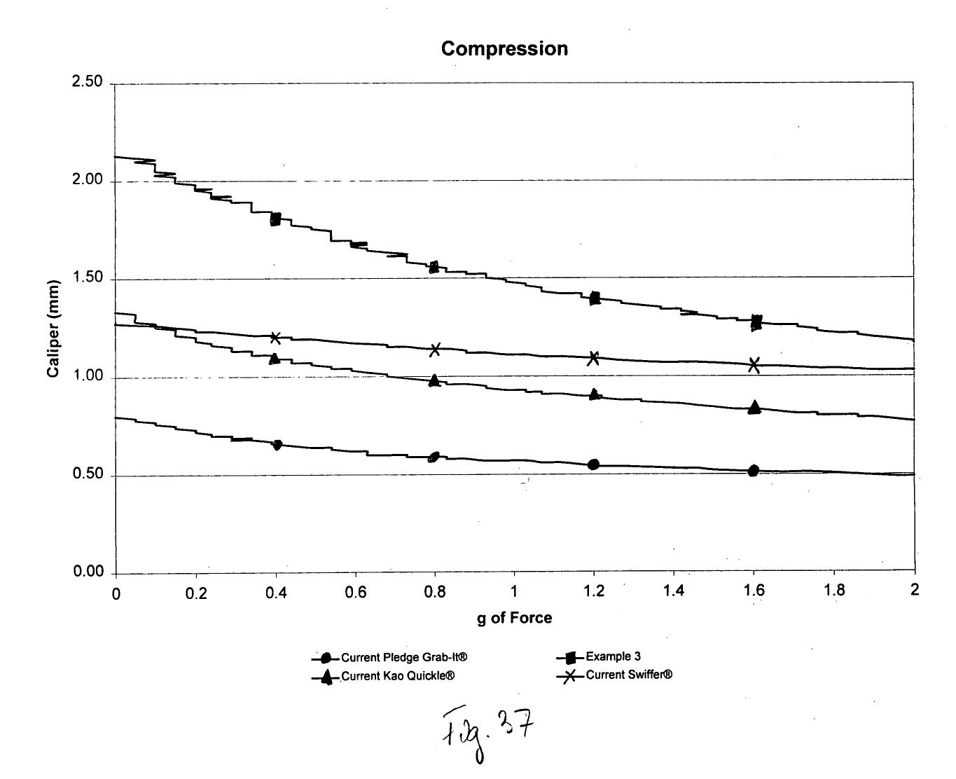

A digital video camera (recording at about 30 frames/sec) located on the side of the two blocks of PLEXIGLAS® 180 and 380 and connected to a microscope (with a 0.75× magnification level) is used to film the evolution of the pillow members 1280 once they reach the grout line 1180 and then expand within the grout line while the cleaning sheet is being pulled in the direction indicated by an arrow in FIGS. 31 and 33.

FIG. 31 is a magnified picture of the previously described experiment while the cleaning sheet 280 is moved in the direction indicated by the arrow D and showing a pillow member 1280 which has been marked with a drop of black ink, before it reaches the grout line.

FIG. 32 is a magnified picture of the previously described experiment while the cleaning sheet 280 is moved further in the direction indicated by the arrow D and showing the pillow member 1280 shown in FIG. 31 when it has reached the grout line 1180 and starts to expand within the grout line as shown by the increase in size of the black mark shown by the arrow P.

FIG. 33 is magnified a picture of the previously described experiment while the cleaning sheet 280 is moved even further in the direction indicated by the arrow D and showing the pillow member 1280 shown in FIG. 32 when it has fully expanded within the grout line 1180 as shown by the increase in size of the black mark shown by the arrow P.

FIGS. 31-33 show that the pillow members are capable to conform to the change in topography of the hard surface being cleaned. The pillow members are capable of expanding within grout lines and, as a result, are able to dislodge particulates from the grout lines. One skilled in the art will understand that similar benefits are obtained when the pillow members reach a pronounced incline such as a transition strip on a hard surface.

As previously discussed, the flow path created by a plurality of pillow members which are preferably arranged on at least one of the outer surfaces of the sheet to create a non-random pattern, allows the particulates to “flow” towards the middle portion of the sheet during the cleaning operation.

In order to visualize the effect of a three-dimensional pattern having pillow members on dirt/particles and its ability to direct the particles towards the middle portion of the sheet, the following experiment is done.

Particulate Flow Experiment.

About 0.5 grams of a mixture of dirt, dust, and other typical particulate material are evenly applied on the top surface of a transparent floor surface (of at least about 90 cm by 90 cm). The mixture used for this experiment are representative of the kind which can be recovered from the reservoir of a vacuum cleaner and which can be found on a typical floor surface.

A cleaning sheet is mechanically attached to the mop head of a SWIFFER® cleaning implement having either a “crowned” and textured bottom surface or a flat bottom surface. Starting at one corner of the transparent surface, the cleaning sheet attached to the mop head is used to wipe this transparent surface in a forward motion (i.e., the front edge of the sheet is always interacting with the dust/particles). Before the mop head reaches one of the edges of the transparent floor surface, the mop head is rotated in order to clean another area of the transparent surface. While the mop head is moved across the transparent surface and the cleaning sheet collects the dust/particles, a digital video camera (recording at about 30 frames/sec) located underneath the transparent floor, is used to film the surface of the cleaning sheet and the behavior of the dust/particles.

Several images, showing the level of dust/particles at the bottom surface of the cleaning sheet are then “extracted” from the digital video tape to show the evolution of the level of dust/particles at the bottom of the sheet as well as to observe the evolution (or migration) of the dust/particles towards the middle portion of the sheet. This experiment is done with the sample sheet having pillow members on one of its outer surfaces and made according to example 3 supra.

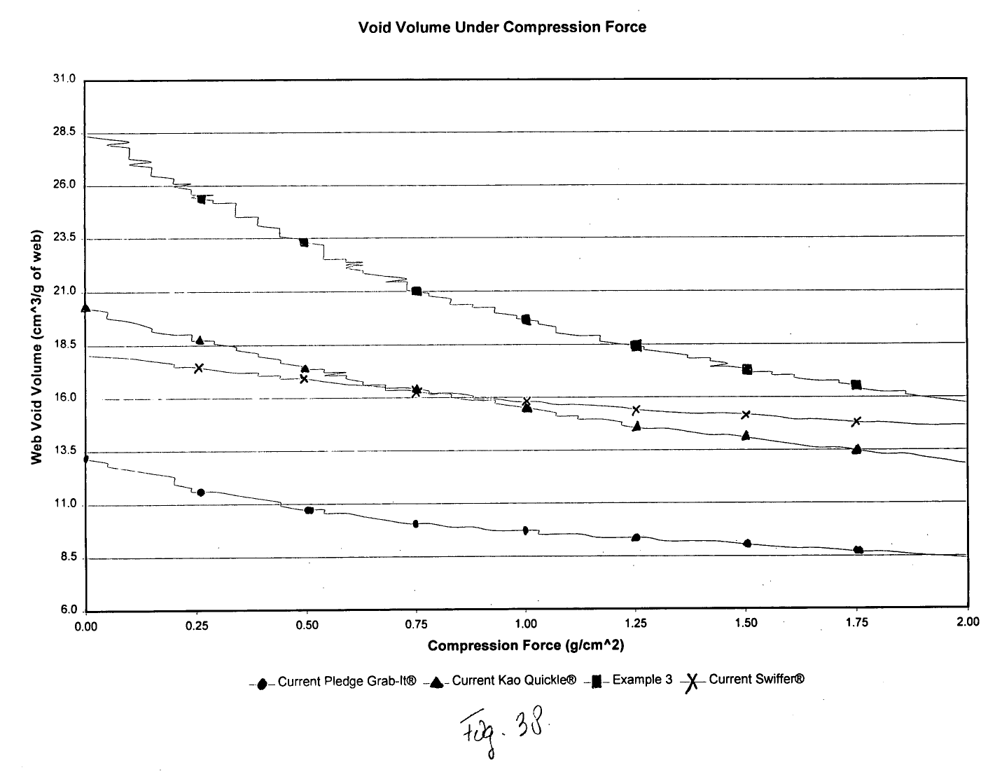

FIGS. 34 through 36 are pictures of the bottom surface of a cleaning sheet 85 having a three-dimensional pattern comprising V-shape pillow members, which are taken at various time intervals during this experiment. This cleaning sheet is made according to the process described in Example 3 supra. The cleaning sheet is attached to the mop head of a SWIFFER® cleaning implement having a “crowned” and textured bottom surface.

FIGS. 34 through 36 show that an increasing portion of the cleaning sheet gets darker which indicates a greater sheet surface utilization during the mopping process. Further observation of the mopping process shows that a cleaning sheet comprising a three-dimensional pattern with a plurality of pillow members and distinct channels or flow paths for particulates provides regional functionality: The pillow members trap dirt/particles while channels allow the loose dirt/particles 185 to flow towards the middle portion of the sheet. The dust/particles collected on the front leading edge portion of the sheet periodically migrate towards the middle portion of the sheet. In addition, FIG. 34 through 36 show that the pockets created by the V-shape pillow members get rapidly filled with dust/particles.

It is observed that when a similar cleaning sheet is attached to a mop head having a substantially flat surface, similar benefits are achieved despite the flat bottom surface of the mop head and particulates are able to move to a certain degree towards the middle portion of the sheet.

Consequently, a cleaning sheet with a flow path for particulates and a macroscopic three-dimensional pattern, created by pillow members, has a much greater usable area available for trapping dust/particles in comparison with more conventional cleaning sheets.

When a hard surface is wiped with a cleaning sheet made of a fibrous material, the particles located on the hard surface are trapped by the sheet because they get entangled between the fibers of the sheet. Consequently, the cleaning efficacy of a sheet made of a fibrous material depends in part of the amount of pores and void volume present in the sheet. One skilled in the art will understand that a cleaning sheet having more void volume is more likely to trap more and/or larger particulates.

During the cleaning operation of a hard surface with a cleaning sheet, the cleaning sheet is “sandwiched” between either the user's hand or a cleaning tool, and the hard surface being cleaned. As a result, the cleaning sheet is subjected to a compressive load of pressure which varies between about 0 g/cm² (corresponding to the low level of pressure associated with hand dusting) and about 20 g/cm² (corresponding to the maximum pressure applied by a user on the handle) and which is mainly applied in the Z dimension of the sheet. This compressive load tends to flatten the sheet and, as a result, reduces the amount of void volume in the sheet. A user typically pushes the mop head forward and then either pulls on the mop head, lifts it from the floor surface to bring the mop head closer to him/herself or rotates the mop head. Without intending to be bound by any theory, it is believed that when the user pushes the mop head forward, the pressure applied on the sheet gradually increases until the user changes the movement direction of the mop head. Consequently, a cleaning sheet maintaining a high amount of void volume while the cleaning is being compressed, has an improved cleaning efficacy since the sheet is capable of trapping more and/or larger particulates. The cleaning sheet, having a three-dimensional pattern created by pillow members as previously described, is able to maintain a relatively high amount of void volume as the user wipes the hard surface.

In order to evaluate the amount of void volume in a cleaning sheet at a relaxed state and during the cleaning operation, the following experiment is conducted.

Compression Analysis Methodology:

The compression characteristics of a fibrous substrate can be obtained by measuring a web's resistive force to compression as the web is being subjected to an increased deformation.

The following substrates are tested:

PLEDGE GRAB-IT® cleaning sheets, sold by the S.C. Johnson Company, which are made via a spunlace process in which carded polyester fibers are hydroentangled around a polypropylene scrim netting material.

QUICKLE® cleaning sheets sold by the Kao Company which is made via a spunlace process in which carded polyester fibers are hydroentangled around a polypropylene scrim netting material. During the spunlace process, the web is hydroentangled on a forming belt.

SWIFFER® cleaning sheets which are made via a spunlace process in which two layers of carded polyester staple fibers are hydroentangled around a polypropylene spunbond web.

Samples of cleaning sheets having a three-dimensional pattern such as the one described in Example 3 supra.

Five test sample of each type of substrate are prepared by cutting pieces of substrate measuring about 5 cm by 5 cm from a cleaning sheet. The five test samples of the same type of substrate having a three-dimensional pattern are cut from a cleaning sheet such that they all include the same number of pillow members.

The compression data is obtained from a Kawabata Evaluation System consisting of a mechanical unit, an electronic interface unit, and a computer. The mechanical and electronic interface units together are known as a Kawabata KES-FB3 Compression Tester, No. 9900217CS (made by Kato Tech Co., LTD.; 26 Karato-cho; Nishikujo, Minami-ku; Kyoto, 601-8447 Japan). This instrument is calibrated by the manufacturer annually. In order to complete a compression force analysis on a web sample, the instrument is zeroed before each experiment, The Kawabata Evaluation System Measurement Program software is set as follows: (1) Select the FB-3 Standard test (for compression testing) and (2) in the compression property optional condition table, the following items are selected in each of the categories:

| Category | Button/Value Selected or Input |
|---|---|
| Sample | Fabrics, Films |
| Sens. | 2 × 5 |
| Velocity (sec/mm) | 50 |
| Stroke (mm/10 V) | 5 |
| Comp. Area (cm²) | 2 |
| Process rate (sec) | 0.5 |
| Maximum load (gf/cm) | 3 |
| Repetition | 1 |

After this initial setup, the instrument is manually adjusted so that the gap between the compressing and compressed plates (which both measure about 2 cm²) is large enough to insert one of the 5 cm×5 cm substrate samples on the compressed plate (with the remaining portion of the web resting on top of the surrounding sample table). The sample of the substrate having pillow members on one of its sides, is placed on the compressed plate such that the pillow members point towards the compressing plate. The compressing plate is then again manually lowered towards the sample until the instrument detects an initial compressive load. The compressing plate is then manually retracted until the compressive load returns to zero. The instrument is linked to the computer by pressing the ‘INT’ button on the electronic unit. Clicking the ‘Start Measurement’ key in the COMPRESSION drop-down menu on the computer starts the analysis of the web. After the measurement process is completed (i.e., maximum pressure reached in compression and subsequent return to the original compressing plate location), the results, the distance the compressing plate traveled versus the amount of force applied, are recorded and then transferred to MICROSOFT® EXCEL for further analysis. The machine is then decoupled from the PC by pressing the ‘FORCE’ button located on the electronic interface unit. Then the GAP-SET dial is rotated to manually raise the compressing plate to remove the sample. This process was repeated for each sample. The thickness of the web at any compression force can be calculated (through MICROSOFT® EXCEL) by subtracting the compressing plate travel distance from the initial gap setting of the sample (at zero compressive force).

During this experiment, a piece of web is placed on the compressed plate such that the X-Y plane of the web is substantially parallel to the compressed plate which is located directly above a load cell and a moveable compressing plate is moved in the Z-dimension at a speed of about 0.02 mm/sec in order to compress the web against the compressed plate. Each web sample is compressed until the load cell indicates that a compressive force of about 3.0 g/cm² is applied to the web sample. The data is recorded every 0.5 seconds until the test is completed.

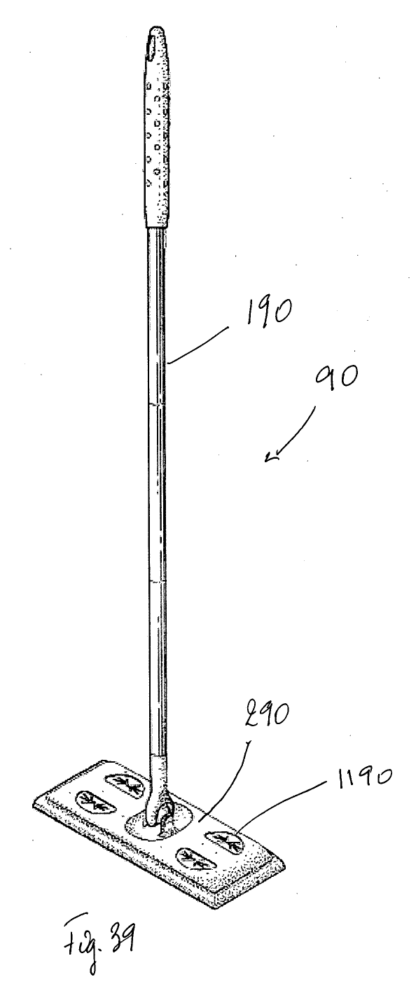

Five samples of each type of substrate are tested and the results of the median curve is plotted to obtain the graph shown in FIG. 37 which represents the thickness of each type of substrate as a function of the amount of compressive force applied to the substrate.

Determination of Web Void Volume:

The void volume of the substrate can be approximated from its basis weight and thickness as disclosed in U.S. Pat. No. 5,562,650, to Everett et al., issued Oct. 8, 1996, and assigned to the Kimberly-Clark Company. With respect to the examined webs, the weight and thickness are measured on unfolded sheets. The basis weight is determined by weighing a dry sheet sample (of about 10 cm×10 cm) of known area and converting the result mathematically to the units of grams of web per square meter. The thickness (measured in mm) of the sheet is obtained using the Kawabata Evaluation System during a web compression test as previously described. The initial non-compressed sheet thickness is the initial gap setting as determined/described above.

The “apparent density” of the web can be calculated by dividing the basis weight of the substrate by the thickness of the substrate, with the appropriate conversion of units in order to obtain a result expressed in g/cm³. This method of calculating the “apparent density” of a substrate can be found in U.S. Pat. No. 4,515,656 to Memeger, Jr., issued May 7, 1985, and assigned to the E. I. DuPont de Nemours and Company. For all sheets, whether relatively flat, three dimensional, or three dimensional with pillow members, thickness is measured perpendicular to the plane of the sheet. As described, for non-relatively flat sheets, the thickness of the highly expanded portion of the sheet is used in computing “apparent” density (i.e., the density of the sheet would have if all the areas of he sheet has been expanded uniformly to the same maximum degree). In other words, “apparent density” is computed as space occupied by the expanded sheet between flat plates (i.e., the initial gap distance between the compressed plate and compressing plate of the Kawabata Compression Tester). The “apparent density” is defined as:

$$ρ = \frac{BW}{t} \times {10}^{- 3}$$

where:
ρ=“apparent” density (g of web/cm³)
BW=basis weight (g/m²)
τ=thickness (mm) at zero compression force (no load, initial gap setting)

In all further discussions, this “apparent” density value will be used to calculate the apparent void volume of the samples. The apparent void volume of a fibrous nonwoven web is a measure of how much air space (i.e., or porosity) is present in the structure. The fiber free void volume is the web's apparent void volume minus the fiber's specific volume. For the purposes of this invention, the fiber free void volumes of interest may approximately equal the apparent void volume since the fiber specific volume is much less than the fiber free volume. Therefore, the web void volume of the fibrous nonwoven is defined as:

$${VoidVol}_{web} = \frac{1}{ρ}$$

where:
VoidVol_{web}=web void volume (cm³/g of web)
   ρ=“apparent” density (g of web/cm³)

One skilled in the art will understand that the apparent density and web void volume can be determined for various compressive loads from the thickness data generated by the Kawabata Compression Tester in the previous experiment. As summarized above, The Kawabata Evaluation System will measure and report the web's compressive force at various web thicknesses as the web is compressed. By knowing or calculating the basis weight of a web and the compressed thickness of the web, one can determine the web void volume at a particular compressive load. These results are shown in FIG. 38.

FIG. 38 shows that when a compressive load of less than about 0.5 g/cm² is applied on the cleaning sheet having a three-dimensional pattern created by pillow members, the amount of void volume is at least about 21 cm³/g of web, preferably at least about 22 cm³/g of web and more preferably at least about 23 cm³/g of web.

FIG. 38 also shows that when a compressive load of between about 0.5 g/cm² and about 1 g/cm² is applied on the cleaning sheet having a three-dimensional pattern created by pillow members, the amount of void volume is at least about 17.5 cm³/g of web, preferably at least about 18.5 cm³/g of web and more preferably at least about 19.5 cm³/g of web.

FIG. 38 shows that when a compressive load of between about 1 g/cm² and about 1.75 g/cm² is applied on the cleaning sheet having a three-dimensional pattern created by pillow members, the amount of void volume is at least about 16 cm³/g of web.

Without intending to be bound by any theory, it is believed that a portion of the fibers which form the pillow members and which are located outside of the X-Y plane, act as “springs” which prevent the pillow members to be completely flatten by the compressive load. The fibers contribute to maintain a high level of porosity within the pillow members during the cleaning operation and, consequently, increase the “cleaning efficacy” of the sheet. One skilled in the art will understand that the closer to the Z axis these fibers are, the higher the resistance to compression and the greater the “cleaning efficacy” of the sheet will be.

Consequently, the previously described cleaning sheets having pillow members are capable of maintaining a relatively high void volume during use and have a higher cleaning efficacy.

One skilled in that art will appreciate that the previously disclosed cleaning sheet having a macroscopic three-dimensional pattern created by a plurality of pillow members can also be used in order to form a mitt as disclosed in U.S. Pat. No. 5,968,204 to Wise, issued Oct. 19, 1999 and assigned to The Procter & Gamble Company, such that at least one of the outer surfaces of the mitt comprises a macroscopic three-dimensional pattern created by a plurality of pillow members.

V. Additives.

The cleaning efficacy of any of the previously described cleaning sheets comprising pillow members can be further improved by applying an additive on at least one of the outer surface of the sheet, preferably the outer surface having the pillow members.

In one embodiment, an additive can be applied on the outer surface of the sheet comprising a plurality of pillow members such that the additive is uniformly located on this outer surface.

In another embodiment, an additive can be applied on the outer surface of the sheet comprising a plurality of pillow members such that the previously described flow paths are coated with the additive and the upper portion of the pillow members is substantially free from any additive.

In another embodiment, an additive can be applied on the outer surface of the sheet comprising a plurality of pillow members such that the upper portion of the pillow members is coated with the additive and the flow paths are substantially free from any additive.

In another embodiment, an additive can be applied on the outer surface of the sheet comprising a plurality of pillow members such that the additive is not uniformly located on the outer surface in the X-Y plane. In one embodiment, the center longitudinal portion of the sheet (about 33% of the sheet width) comprises a higher level of additive than the two outer portions of the substrate which are respectively adjacent to the front and back leading edges of the sheet.

Non-limiting examples of suitable additive include oils, waxes, tacky polymers and mixtures thereof.

Use of the preferred lower levels, especially of additives that improve adherence of soil to the sheet, provides surprisingly good cleaning, dust suppression in the air, preferred consumer impressions, especially tactile impressions, and, in addition, the additive can provide a means for incorporating and attaching perfumes, pest control ingredients, antimicrobials, including fungicides, and a host of other beneficial ingredients, especially those that are soluble, or dispersible, in the additive. These benefits are by way of example only. Low levels of additives are especially desirable where the additive can have adverse effects on the substrate, the packaging, and/or the surfaces that are treated.

Non-limiting examples of suitable additives are described in U.S. patent application Ser. No. 09/082,349 to Fereshtehkhou et al., filed May 20, 1998, and assigned to The Procter & Gamble Company and in copending U.S. provisional patent application Ser. No. 60/448,745 to Policicchio et al., filed Feb. 20, 2003, and assigned to the Procter & Gamble Company.

In a preferred embodiment, the additive comprises a micro-crystalline wax.

VI. Cleaning Implement.

The cleaning sheets previously described can be used separately for hand dusting, or in combination with a cleaning tool.

FIG. 39 shows a cleaning tool 90 which comprises a handle 190 and preferably includes a mop head 290 rotatably connected the handle 190. An example of cleaning tool is described in U.S. patent application Ser. No. 09/788,761 to Willman et al., filed Feb. 24, 2000, and assigned to The Procter & Gamble Company. The mop head can have any shape or size and includes attachment structures 1190 for retaining a cleaning sheet about the mop head as described in U.S. Pat. No. 6,305,046 to Kingry et al., issued Oct. 23, 2001, and assigned to The Procter and Gamble Company, but one skilled in the art will understand that any other kind of retaining means can be used to retain a cleaning sheet and provide the same benefits.

Another suitable type of cleaning tool is disclosed in International Patent Application WO 02/34101 to Tanaka, published May 2, 2002, and assigned to the Uni-Charm Corporation which comprises a mop body which is removably attachable to a handle.

While particular embodiments of the subject invention have been described, it will be apparent to those skilled in the art that various changes and modifications of the subject invention can be made without departing from the spirit and scope of the invention. In addition, while the present invention has been described in connection with certain specific embodiments thereof, it is to be understood that this is by way of limitation and the scope of the invention is defined by the appended claims which should be construed as broadly as the prior art will permit.

1. A cleaning sheet for removing particulates from a hard surface comprising:
a substrate, said substrate having a length and a width, said substrate comprising a first side and a second side wherein said first side comprises a plurality of pillow members and wherein said pillow members create a macroscopic three-dimensional pattern on said first side.

2. The cleaning sheet of claim 1 wherein said substrate comprises at least a first layer and a second layer of a fibrous nonwoven material.

3. The cleaning sheet of claim 1 wherein said macroscopic three-dimensional pattern is a non-random pattern.

4. The cleaning sheet of claim 3 wherein said pillow members have a length Lp between about 2 mm and about 125 mm, a width Wp between about 2 mm and about 125 mm, a height Hp between about 0.5 mm and about 12 mm.

5. The cleaning sheet of claim 4 wherein said first side comprises a plurality of rows of pillow members such that the distance Dpx between two consecutive pillow members of a same row is between about 0.1 and about 10 mm and the distance Dpy between two adjacent pillow members of two consecutive rows is between about 0.1 and about 10 mm.

6. The cleaning sheet of claim 4 wherein said first side comprises a plurality of rows of pillow members and wherein the pillow members located on the odd rows are offset relative to the pillow members located on even rows such that distance Dt between pillow members located on two consecutive rows is between about 0.1 mm and about 10 mm.

7. The cleaning sheet of claim 4 wherein said first side has a front and back leading edge and a middle portion wherein said first side comprises a flow path in between said pillow members such that said particulates migrate towards said middle portion within said flow path when said hard surface is wiped with said substrate and said first side contacts said hard surface.

8. The cleaning sheet of claim 3 wherein said pillow members are longitudinal pillow members having a length Llp between about 3 mm and about 250 mm, a width Wlp between about 1 mm and about 50 mm and a height Hlp between about 0.5 mm and about 12 mm.

9. The cleaning sheet of claim 8 wherein said first side has a front and a back leading edge and wherein said first side comprises a plurality of longitudinal pillow members such that the angle β between the longitudinal axis of the pillow members and the leading edge of said first side is between about 10 and about 80 degrees.

10. The cleaning sheet of claim 3 wherein said pillow members are V-shape pillow members wherein said V shape pillow members have a first and a second longitudinal segment wherein said first leg is connected to said second leg thereby forming a pocket.

11. The cleaning sheet of claim 10 wherein the closed angle δ between said first longitudinal segment and said second longitudinal segment is between about 5 and about 175 degrees.

12. The cleaning sheet of claim 11 wherein said first side comprises a plurality of rows of V-shape pillow members.

13. The cleaning sheet of claim 12 wherein said first side has a first half portion and a second half portion wherein the V-shape pillow members located on said first half portion point towards said front leading edge and said V-shape pillow members located on said second half portion point towards said back leading edge.

14. The cleaning sheet of claim 12 wherein at least two V-shape pillow members of a row point towards opposite directions.

15. The cleaning sheet of claim 14 wherein consecutive V-shape pillow members of a row point towards opposite directions.

16. The cleaning sheet of claim 10 wherein said pockets of said V-shape pillow members collect said particulates when said hard surface is wiped with said cleaning sheet and said first side contacts said hard surface.

17. The cleaning sheet of claim 10 wherein said first side has a front and back leading edge and a middle portion wherein said first side comprises a flow path in between said V-shape pillow members such that said particulates migrate towards said middle portion within said flow path when said hard surface is wiped with said substrate and said first side contacts said hard surface.

18. The cleaning sheet of claim 1 wherein said substrate has a basis weight of at least about 40 g/m².

19. The cleaning sheet of claim 18 wherein said basis weight is between about 50 g/m² and about 90 g/m².

20. The cleaning sheet of claim 1 wherein said hard surface has a surface topography which varies along said hard surface and wherein pillow members conform to the surface topography of said hard surface when said hard surface is wiped with said cleaning sheet and said first side contacts said hard surface.

21. The cleaning sheet of claim 1 wherein at least one of said first or second sides comprise an additive.

22. The cleaning sheet of claim 2 wherein said pillow members are created by portions of said first layer expanding in the Z-dimension away from corresponding portions of said second layer.

23. The cleaning sheet of claim 22 wherein said pillow members have a volume in between said portions of said expanding portion of said first layer and said corresponding portions of said second layer.

24. The cleaning sheet of claim 23 wherein fibers of said first layer are located within said volume of said pillow members.

25. A cleaning kit comprising:
at least one cleaning sheet according to claim 1; and
a cleaning implement comprising a handle.

26. A method of removing particulates from a hard surface comprising:
providing a cleaning sheet according to claim 1; and
contacting said hard surface with said first side of said cleaning sheet.

27. A cleaning sheet for removing particulates from a hard surface comprising:
a substrate having a length, a width and a thickness, said substrate comprising at least one layer of fibrous nonwoven material, wherein said substrate has a void volume of at least about 21 cm³/(gram of substrate) when said substrate is subjected to a compressive force of at least about about 0.5 g/cm².

28. The cleaning sheet of claim 27 wherein said void volume is at least about 22 cm³/(gram of substrate) when said substrate is subjected to a compressive force of at least about about 0.5 g/cm².

29. The cleaning sheet of claim 28 wherein said void volume is at least about 23 cm³/(gram of substrate) when said substrate is subjected to a compressive force of at least about about 0.5 g/cm².

30. The cleaning sheet of claim 27 wherein said substrate has a void volume of at least about 17.5 cm³/(gram of substrate) when said substrate is subjected to a compressive force of between about 0.5 g/cm² and about 1 g/cm².

31. The cleaning sheet of claim 30 wherein said substrate has a void volume of at least about 18.5 cm³/(gram of substrate) when said substrate is subjected to a compressive force of between about 0.5 g/cm² and about 1 g/cm².

32. The cleaning sheet of claim 31 wherein said substrate has a void volume of at least about 19.5 cm³/(gram of substrate) when said substrate is subjected to a compressive force of between about 0.5 g/cm² and about 1 g/cm².

33. The cleaning sheet of claim 27 wherein said substrate comprises a first side and a second side wherein said first side comprises a plurality of pillow members and wherein said pillow members create a macroscopic three-dimensional pattern on said first side.

34. The cleaning sheet of claim 33 wherein said macroscopic three-dimensional pattern is a non-random pattern.

35. The cleaning sheet of claim 34 wherein said pillow members have a length Lp between about 2 mm and about 125 mm, a width Wp between about 2 mm and about 125 mm, a height Hp between about 0.5 mm and about 12 mm.

36. A method of removing particulates from a hard surface comprising:
providing a cleaning sheet according to claim 27; and
contacting said hard surface with said first side of said cleaning sheet.

37. A cleaning kit comprising:
at least one cleaning sheet according to claim 27; and
a cleaning implement comprising a handle.

38. A cleaning sheet for removing particulates from a hard surface comprising:
a substrate having a length, a width and a thickness, said substrate comprising at least one layer of fibrous nonwoven material, wherein said substrate has a void volume of at least about 17.5 cm³/(gram of substrate) when said substrate is subjected to a compressive force of between about 0.5 g/cm² and about 1 g/cm².

39. The cleaning sheet of claim 38 wherein said substrate has a void volume of at least about 18.5 cm³/(gram of substrate) when said substrate is subjected to a compressive force of between about 0.5 g/cm² and about 1 g/cm².

40. The cleaning sheet of claim 39 wherein said substrate has a void volume of at least about 19.5 cm³/(gram of substrate) when said substrate is subjected to a compressive force of between about 0.5 g/cm² and about 1 g/cm².

41. The cleaning sheet of claim 38 wherein said substrate comprises a first side and a second side wherein said first side comprises a plurality of pillow members and wherein said pillow members create a macroscopic three-dimensional pattern on said first side.

42. The cleaning sheet of claim 41 wherein said macroscopic three-dimensional pattern is a non-random pattern.

43. The cleaning sheet of claim 42 wherein said pillow members have a length Lp between about 2 mm and about 125 mm, a width Wp between about 2 mm and about 125 mm, a height Hp between about 0.5 mm and about 12 mm.

44. A method of removing particulates from a hard surface comprising:
providing a cleaning sheet according to claim 38; and
contacting said hard surface with said first side of said cleaning sheet.

45. A cleaning kit comprising:
at least one cleaning sheet according to claim 38; and
a cleaning implement comprising a handle.
